(19) United States
(12) Patent Application Publication
(10) Pub. No.: US 2008/0215456 A1
(43) Pub. Date: Sep. 4, 2008

(54) SYSTEMS AND METHODS FOR FACILITATING EXCHANGES OF ITEMS

(75) Inventors: Andrew D. West, Charlestown, MA (US); Thomas D. West, Charlestown, MA (US)

Correspondence Address: SEED INTELLECTUAL PROPERTY LAW GROUP PLLC, 701 FIFTH AVE, SUITE 5400, SEATTLE, WA, 98104, US

(73) Assignee: AuctionPal, LLC, Boston, MA (US)

(21) Appl. No.: 11/697,693

(22) Filed: Apr. 6, 2007

Related U.S. Application Data
(60) Provisional application No. 60/865,814, filed on Nov. 14, 2006.

(51) Int. Cl. G07G 1/12

(52) U.S. Cl. 705/27

(57) ABSTRACT

Enhanced methods, systems, and techniques for facilitating item exchange are provided. Example embodiments provide an Exchange Facilitator System (“EFS”), which facilitates listing and sale of items offered for sale by sellers via one or more third-party item exchange systems. In some embodiments, the EFS obtains information about an item offered for sale by a seller, and automatically generates a listing for the item, based on the information about the item and information about other items sold on one or more item exchange systems. The EFS may then electronically provide the generated item listing to an item exchange system, and further manage the progress and sale of the item via the item exchange system. This abstract is provided to comply with rules requiring an abstract, and is submitted with the intention that it will not be used to interpret or limit the scope or meaning of the claims.

### TECHNICAL FIELD

The present disclosure relates to methods and systems for facilitating exchange of items and, in particular, to methods and systems for facilitating the sale of an item offered for sale by a seller via a third-party item exchange system.

### BACKGROUND

A number of approaches exist for selling goods on the Internet. In one approach, an online auction site manages auctions for goods that are offered for sale by sellers. In this model, a seller may provide to the auction site information (e.g., an image, a textual description, etc.) about a good offered for sale. The auction site then manages an auction for the good by taking bids from multiple prospective buyers for a specified time interval. At the end of the time interval, the prospective buyer having entered the highest bid wins the auction and then purchases the good, by providing payment (e.g., to the auction site or an external payment facilitator) and receiving the good from the seller.

Unfortunately, a seller of goods via an online auction typically faces high transaction costs associated with the use of the online auction. For example, it may take the seller considerable time and effort to actually list a good on the online auction, because he may have to provide images of the good (e.g., by taking photos of the good and uploading such photos to the auction site) as well as develop an accurate, informative, and appealing written description of the good. In some cases, there may be multiple online auctions available to the seller, some of which may be specialized for the sale of particular kinds of goods (e.g., cars. boats, sporting equipment). In such cases, the seller may need to perform research to determine which online auction is likely to yield the best price, the largest community of prospective buyers, etc. In addition, the seller may have to learn to use multiple distinct user interfaces provided by the multiple online auctions. The seller may also face various obstacles after having listed the good for sale. For example, the seller may have to periodically visit the online auction to monitor or otherwise obtain updates related to the progress of the auction. In addition, once the good sells, the seller may bear the cost of packaging and sending the good to the buyer (e.g., time spent waiting in line at the post office, etc.). In some cases, when the cost of selling a good via an online auction is significant, the seller may simply elect not to sell the good, possibly resulting in an economically inefficient outcome.

### BRIEF DESCRIPTION OF THE DRAWINGS

FIG. 1 is an example block diagram illustrating utilization of an example Exchange Facilitator Environment.

FIG. 2 is an example block diagram of components of an example environment for facilitating item exchanges using an Exchange Facilitator System.

FIG. 3 is an example overview flow diagram of example functions provided by an example embodiment of an Exchange Facilitator Environment.

FIG. 4 illustrates an example mobile computing device configured to execute an example local agent client application.

FIG. 5 is an example block diagram illustrating control flow between screens displayed by an example local agent client application.

FIGS. 6A-6O are example screen displays provided by an example local agent client application.

FIGS. 7A-7J are example screen displays provided by an example seller client application.

FIG. 8 illustrates an example mobile phone configured to operate as an example seller client device.

FIG. 9 is an example flow diagram of an example remotely assisted exchange facilitation process.

FIG. 10A-10J are example screen displays provided by a remote agent client application.

FIG. 11 is an example block diagram of a computing system for practicing embodiments of an example Exchange Facilitator System.

FIG. 12 is an example flow diagram of an example item listing management routine provided by an example embodiment of an Exchange Facilitator System.

FIG. 13 is an example flow diagram of an example Item listing criteria optimization routine provided by an example embodiment of an Exchange Facilitator System.

### DETAILED DESCRIPTION

Embodiments described herein provide enhanced computer- and network-based techniques for facilitating exchanges of items. In some embodiments, the techniques include facilitating a sale of an item offered for sale by a seller via a third-party item exchange system. Item exchange systems may include computing systems configured to provide network-accessible marketplaces for goods and/or services, such as online auction sites, online stores or storefronts, online classified advertising sites, electronic marketplaces, etc. Facilitating a sale of an item offered for sale by a seller via a third-party item exchange system may include assisting the seller in listing his item for sale on the third-party item exchange system by, for example, obtaining information about the item from the seller, generating a listing for the item, providing that listing to the third-party item exchange system, tracking the status of the provided listing on the third-party item exchange system, and, when the item is purchased by a buyer, facilitating the delivery of the item from the seller to the buyer.

In some embodiments, the described techniques are performed by an Exchange Facilitator Environment (“EFE”) comprising an Exchange Facilitator System (“EFS”) and one or more client devices. The EFE provides an environment for obtaining information about items offered for sale by sellers and managing the sale of those items via one or more third-party item exchanges. Typically, the third-party item exchanges are operated by entities that are distinct from the entity operating the EFE. A client device may be used by sellers to provide information about items offered for sale to the EFS, possibly with the assistance of an agent associated with the EFS. Agents include local agents (e.g., “hunters”) who seek out items that may be offered for sale by sellers, and, using a client device, provide information about the items and/or sellers to the EFS for purposes of listing the items on one or more third-party item exchange systems. Agents also include remote agents (e.g., sales assistants, experts, consultants) who provide assistance to sellers or local agents in providing and/or listing items for sale. In some embodiments, communication between remote agents and sellers or local agents may be facilitated via the EFS.

The EFS provides various functions and/or services related to the intake of information about items being listed for sale, as well as the listing, sale, and delivery of those items via one or more third-party item exchanges. In particular, the EFS obtains, from a seller and/or agent operating a client device, information about an item being offered for sale by the seller. The EFS also obtains information about one or more third-party item exchanges, including information about items being sold on those item exchanges. The EFS may then generate an effective item listing for the item being offered for sale, based on an analysis of information about the third-party item exchanges, such as information about other items (e.g., similar items being sold on the third-party item exchanges, items having shared and/or similar characteristics and/or attributes, etc.) and features, aspects, and/or characteristics about the third-party item exchanges or exchange mechanisms. Such an analysis may automatically determine criteria, features, characteristics of item listings that are correlated with particular sales outcomes and/or objectives (e.g., high sales prices, short sales time, high buyer satisfaction, etc.). In other embodiments, at least some information analysis may be performed manually, such as by human researchers supported by data analysis and/or research functionality provided by the EFS. In addition, the EFS may determine, based on the obtained information about the item being offered for sale and about the third-party item exchanges, a target third-party item exchange to use that will most likely meet particular sales objectives. The EFS may then manage the sale of the item via the target third-party item exchange by forwarding the generated listing, updating the seller as to the sales progress (e.g., current auction price) of the item, and finalizing the sale and delivery of the item (e.g., transferring payment to the seller, sending shipping materials to the seller so that he can send the item directly to the buyer, etc.).

Generally, the EFE lowers transaction costs associated with the sale items via item exchanges in various ways. First, the EFE provides a uniform interface for listing items for sale on multiple third-party item exchanges, thereby providing a uniform, easy to use platform with which users can interact with multiple distinct systems and/or interfaces provided by those third-party item exchanges. In addition, the EFE provides various additional services (e.g., the selection of target third-party item exchanges, the automatic generation of effective item listings, the management and finalization of item sales, agent assisted selling, etc.) that may allow sellers and/or agents to efficiently provide items for sale. In some embodiments, the EFE may provide such services in exchange for compensation, such as by taking a commission (e.g., a flat fee per item sold, a percentage of the selling price of the item, etc.) from some or all sales of items facilitated by the environment. Other revenue models may also be utilized, such as advertising models (e.g., based on information obtained about sellers and/or items being sold by those sellers), subscription models (e.g., sellers pay a monthly fee to utilize the EFE), etc.

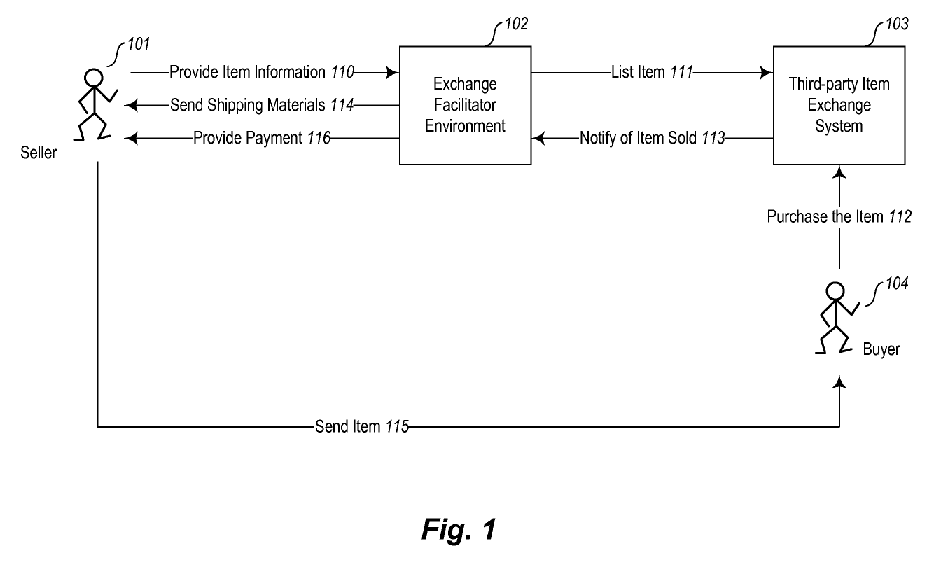

FIG. 1 is an example block diagram illustrating utilization of an example Exchange Facilitator Environment. In the illustrated example, an exchange facilitator environment (“EFE”) 102 facilitates a sale of an item offered for sale by a seller 101 to a buyer 104 via a third-party item exchange system 103. Interactions and/or communication between the seller 101, the exchange facilitator environment 102, the third-party item exchange system 103, and the buyer 104 are illustrated by way of labeled interactions 110-116.

In interaction 110, the seller 101 provides information about the item and the seller 101 to the EFE 102. In some embodiments, interaction 110 may include an interactive communication comprising multiple communications in which the seller 101 provides responses to requests for information (e.g., questions, queries, forms, options, etc.) provided by the EFE 102.

In interaction 111, the EFE 102 lists the item with the third-party item exchange system 103, using determined item listing criteria (e.g., features, aspects, categories, characteristics, etc.) based on the information provided by the seller 101 via interaction 110. In addition, the item listing criteria may be based on an analysis of items sold on the third-party item exchange system 103 that are similar to the item offered for sale by the seller 101. Such an analysis may determine item listing criteria that are correlated with sales objectives and/or preferred outcomes expressed by the seller 101 and/or the exchange facilitator environment 102 (e.g., high sales price, rapid sale, customer type, etc.).

In interaction 112, the buyer 104 purchases the item via the third-party item exchange system 103. In a typical embodiment, the buyer 104 may not know the identity of the seller 101 or that the item is being sold by the EFE 102 on behalf of the seller 101. A purchase may include researching the item, selecting the item, accepting a listed price for the item, making a winning bid in the context of an auction facilitated by the third-party item exchange system 103, initiating a transfer of payment for the item, etc.

In interaction 113, the third-party item exchange system 103 notifies the EFE 102 that the item has been sold. In response, in interaction 114, the EFE 102 initiates the sending of shipping materials to the seller 101. Shipping materials may include packaging materials (e.g., envelopes, boxes, mailers, tape, cushioning, bubble wrap, etc.), instructions (e.g., how to safely ship an item), and a destination address for the item. The amount and type of packaging materials (e.g., amount of tape or bubble wrap) may be automatically determined based on the type and/or other characteristics of the sold item. In some cases, provided shipping materials may be provided pre-labeled with a destination address (e.g., associated with the buyer 104) and/or return address (e.g., associated with the seller 101 and/or the EFE 102). Furthermore, provided shipping materials may be pre-paid for a preferred carrier (e.g., postal service, parcel delivery service, courier service, etc.). After receiving the shipping materials, the seller 101, in interaction 115, sends the item to the buyer 104. In some embodiments, the EFE 102 may interface with various carriers to provide tracking services, such that the seller can monitor the progress of a shipped item to its destination.

In interaction 116, the EFE 102 provides payment to the seller 101, based on the sales price of the item. Payments may be provided in a variety of ways, including sending physical checks, electronic funds transfer, etc. In some embodiments, the EFE 102 may delay the provision of payment (e.g., to prevent or inhibit fraud) to the seller 101 until the occurrence of a particular event, such as receiving notification from the seller 101 that the item has been shipped, receiving notification from the buyer 104 that the item has been received in good condition, or receiving notification from a shipping service that the item has been shipped (e.g., that the item has been sent by the seller 101, is currently in transit to the buyer 104, has been delivered to the buyer 104, etc.).

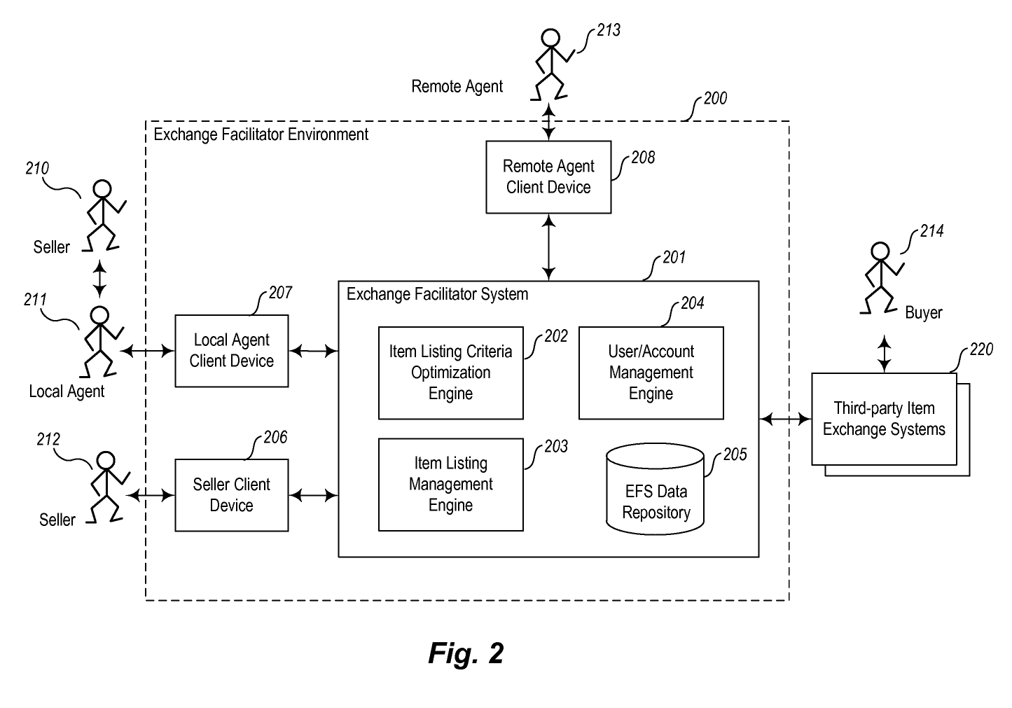

FIG. 2 is an example block diagram of components of an example environment for facilitating item exchanges using an Exchange Facilitator System. The illustrated example depicts an Exchange Facilitator Environment (“EFE”) 200 comprising an Exchange Facilitator System (“EFS”) 201, a seller client device 206, a local agent client device 207, and a remote agent client device 208. The EFS 201 comprises an item listing criteria optimization engine 202, an item listing management engine 203, a user/account management engine 204, and an EFS data repository 205. The illustrated example further depicts a seller 210 interacting with a local agent 211, who is in turn interacting with the local agent client device 207; a seller 212 interacting with the seller client device 206; a remote agent 213 interacting with the remote agent client device 208; and a buyer 214 interacting with one or more third-party item exchange systems 220.

The item listing criteria optimization engine 202 performs various functions related determining various factors, strategies, and/or techniques for listing items for sale in a manner that meets particular sales objectives. In some embodiments, such functions may include automatically obtaining information about the third-party item exchange systems 220, and analyzing the obtained information to identify and/or determine item listing criteria correlated with various sales outcomes. Determined item listing criteria may be stored in the EFS data repository 205 for use by other components of the EFE 200. For example, for a particular item, or type or category of item, the item listing criteria optimization engine 202 may obtain information related to past sales transactions (e.g., purchases, sales, auctions, etc.) of that item on the third-party item exchange systems 220. In addition, the item listing criteria optimization engine 202 may obtain and/or utilize other information from other sources and/or about other factors that may impact sales outcomes, such as general market information (e.g., about levels of demand for particular classes of items, market forecasts, etc.), seasonal information (e.g., about seasonal sales fluctuations due to weather or other factors), regional information (e.g., about regional market differences due to economic, geographic, political, and/or other factors), etc. Based on this obtained information, the item listing criteria optimization engine 202 may automatically determine various features or aspects (e.g., length of item description, particular keywords utilized, number or type of photos or other images provided, etc.) of item listings associated with various sales outcomes (e.g., price at which an item sold, time in which an item sold, etc.).

In addition, the item listing criteria optimization engine 202 may manage item listing criteria provided by other parties and/or computing systems. For example, the item listing criteria optimization engine 202 may additionally obtain information from various other sources, such as government agencies (e.g., that track and/or report statistics related to prices), private appraisers (e.g., that provide specialized knowledge as to the value of particular categories of items), market tracking and reporting services (e.g., Kelly Bluebook), etc. In addition, in some embodiments, one or more of the third-party item exchange systems 220 may publish and/or otherwise provide an interface for specifying characteristics (e.g., dimensions, color, weight, model number, condition, etc.) of items listed on the third-party item exchange systems 220.

Furthermore, human users, such as the remote agent 213, may apply human intelligence to perform research with respect to items sold on the third-party item exchange systems 220 and provide item listing criteria and/or generators for such criteria. Generators for item listing criteria include sets of common questions that are associated with particular items (or types or categories of items) and that may be asked of sellers and/or agents in order to obtain information about an item offered for sale that may be utilized to generate an effective item listing for one or more of the third-party item exchange systems 220. Common questions include questions that may be used to elicit additional information about a seller, an item, a type of item, etc.

In some cases, a collection of common questions (e.g., that may have been initially obtained from human users) may be automatically improved or otherwise modified over time based on various factors, such as question usage, responses received, user feedback, etc. For example, a question may be automatically removed from a database of common questions if they are frequently unanswered by sellers and/or agents (e.g., indicating that perhaps those questions are irrelevant, too complicated, etc.). In addition, new questions may be added to the database of common questions based on sellers and/or agents suggesting and/or voting for additional questions. Furthermore, the system may evaluate the value and/or impact of questions by, for example, comparing sales outcomes (e.g., selling price) of a first set of item listings (e.g., for one category of item) that are not based on a particular question versus sales outcomes of a second set of item listings (e.g., for the same category of item) that are based on the particular question. Differing sales outcomes associated with the two sets of item listings may indicate that the question does impact sales outcomes, and the EFS can accordingly eliminate the question (e.g., if the impact is negative), flag the question for analysis and/or modification by a human user, etc.

The item listing management engine 203 performs various functions related to managing items listed on the third-party item exchange systems 220. Such functions include the intake information about items offered for sale from a seller (e.g., obtaining information about the item and seller), determining an appropriate item exchange system for listing the item, and determining item listing criteria to use in generating an item listing that is provided to the determined item exchange system. Other functions of the item listing management engine 203 include tracking existing offers for sale that have been previously provided by the item listing management engine 203 to various of the third-party item exchange systems 220 and providing sellers and/or agents with periodic updates regarding the status of their offers (e.g., current bid price, etc.). In addition, the item listing management engine 203 facilitates the finalization of accepted offers for sale by notifying a seller that one of their items has been sold, initiating the sending of packaging materials to the seller, and processing payment transactions (e.g., receiving payment for the item from one of the third-party item exchange system 220 on behalf of the seller, providing payment for the item to the seller, etc.). Records or other information relating to new, in-progress, and/or completed sales may be stored in the EFS data repository 205.

The user/account management engine 204 performs management functions related to users and/or accounts associated with the EFE 200. Specifically, the user/account management engine 204 may provide functionality related to managing (e.g., opening, modifying, closing, etc.) accounts that include information about a seller and/or agent, such as name, shipping and/or billing addresses, bank account numbers (e.g., for providing payment), preferred payment mechanisms, preferred third-party item exchange systems, transaction history (e.g., to determine aspects of performance, reliability, and/or veracity of an agent and/or seller), etc. Information about users and/or accounts may be stored in the EFS data repository 205 for use by other components of the EFE 200.

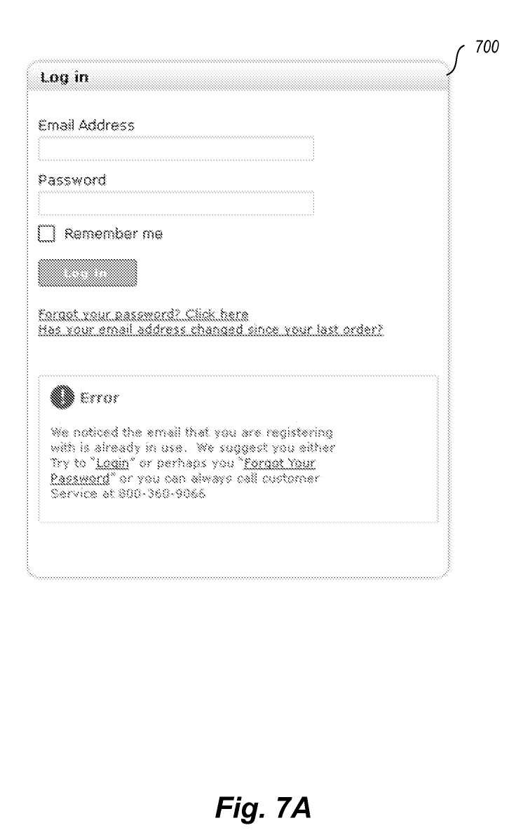

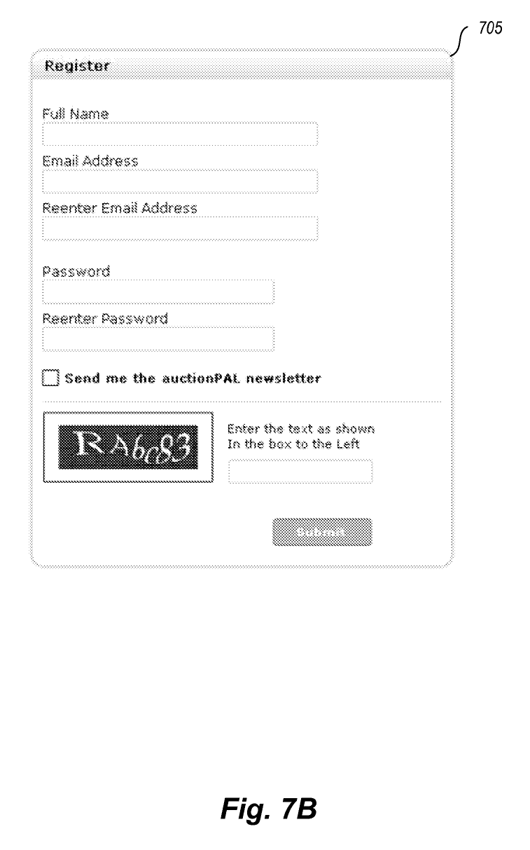

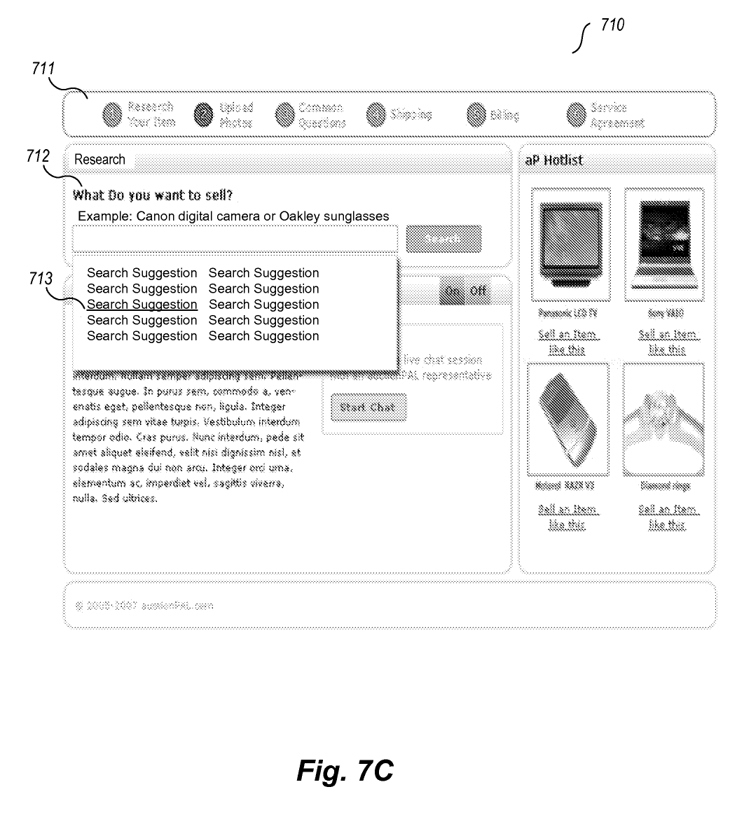

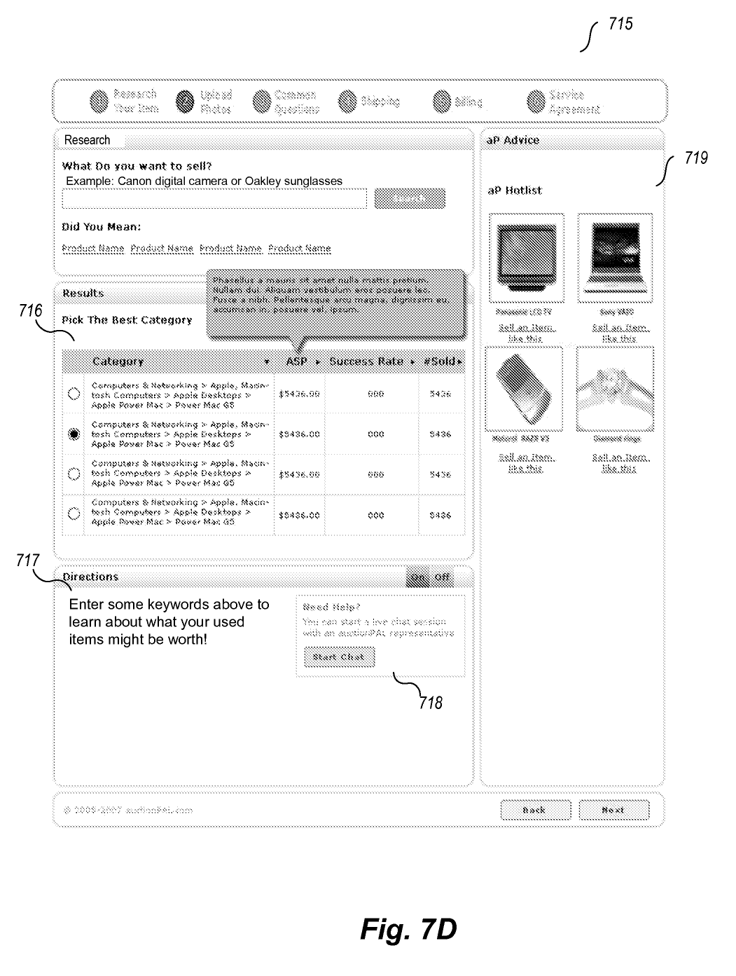

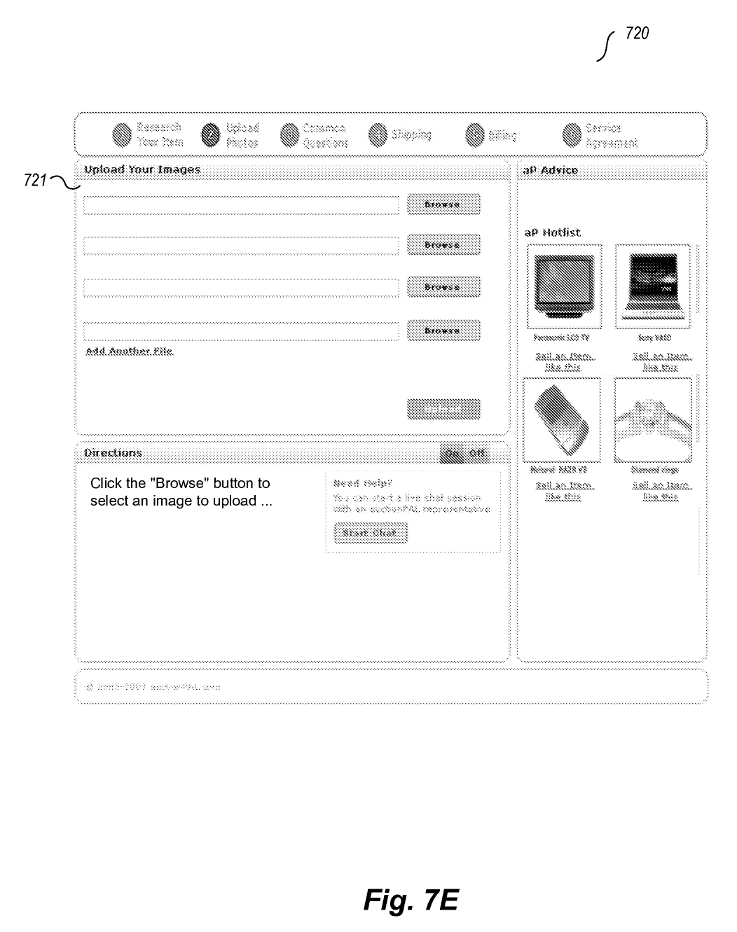

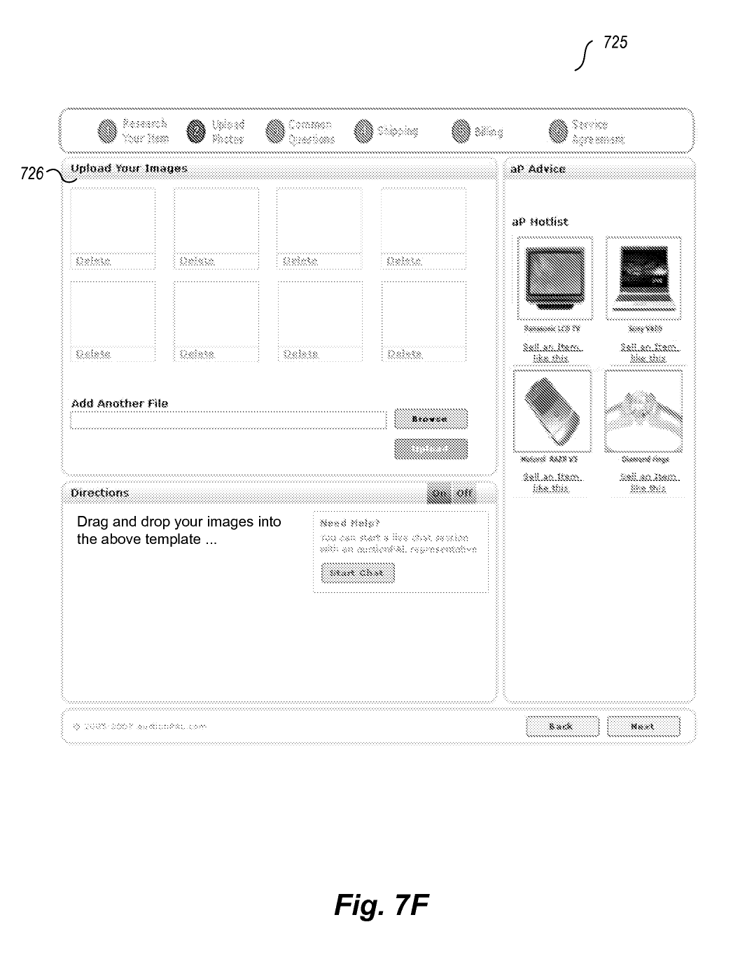

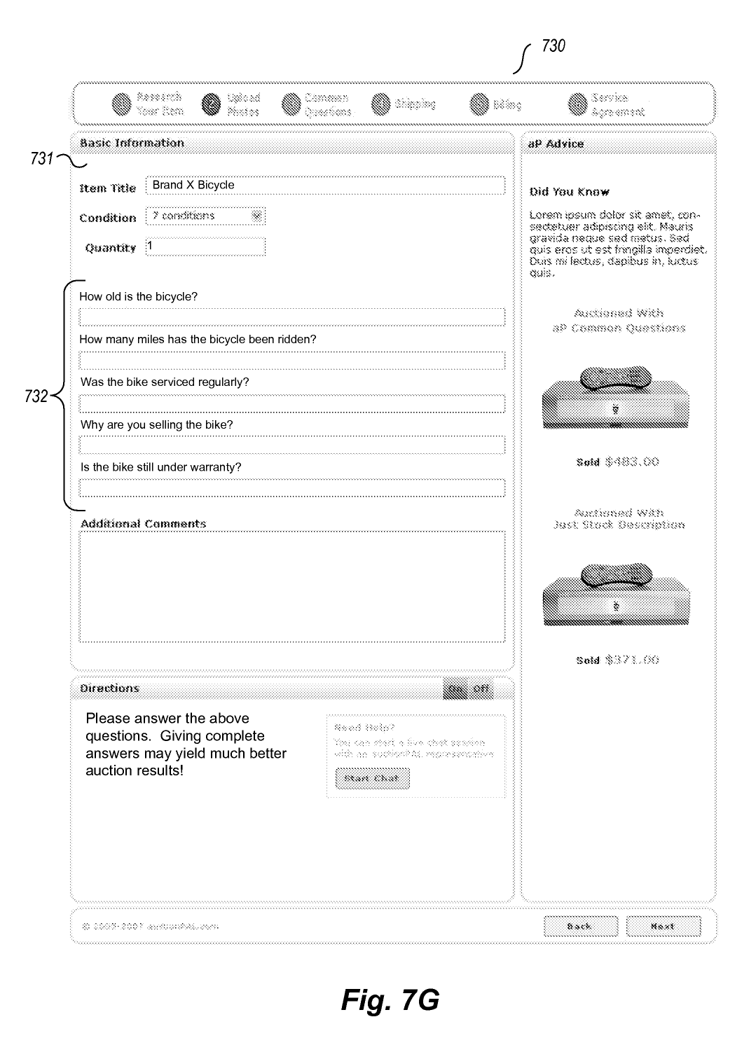

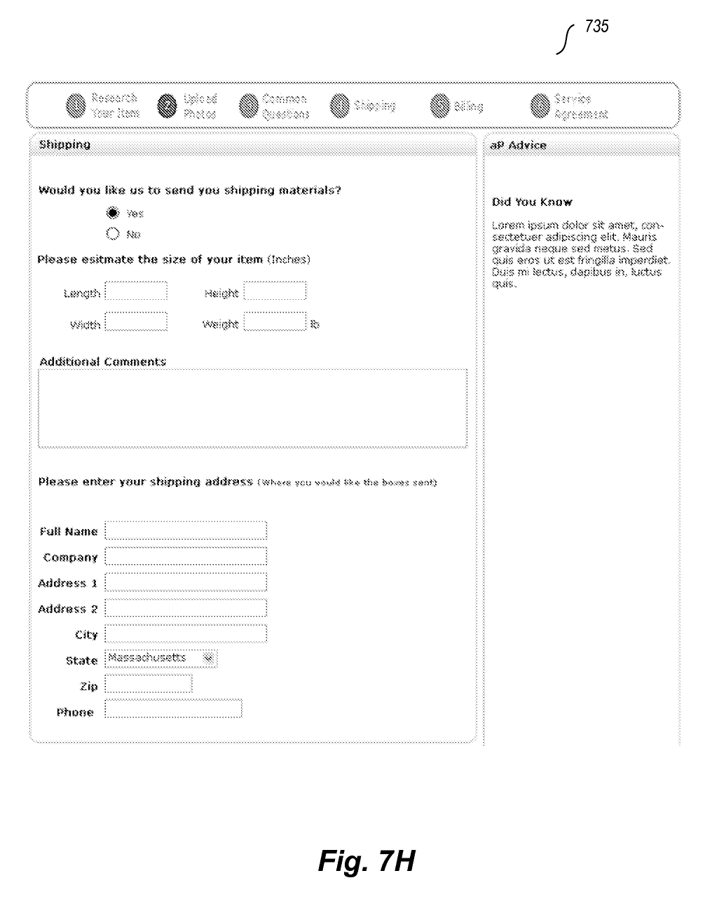

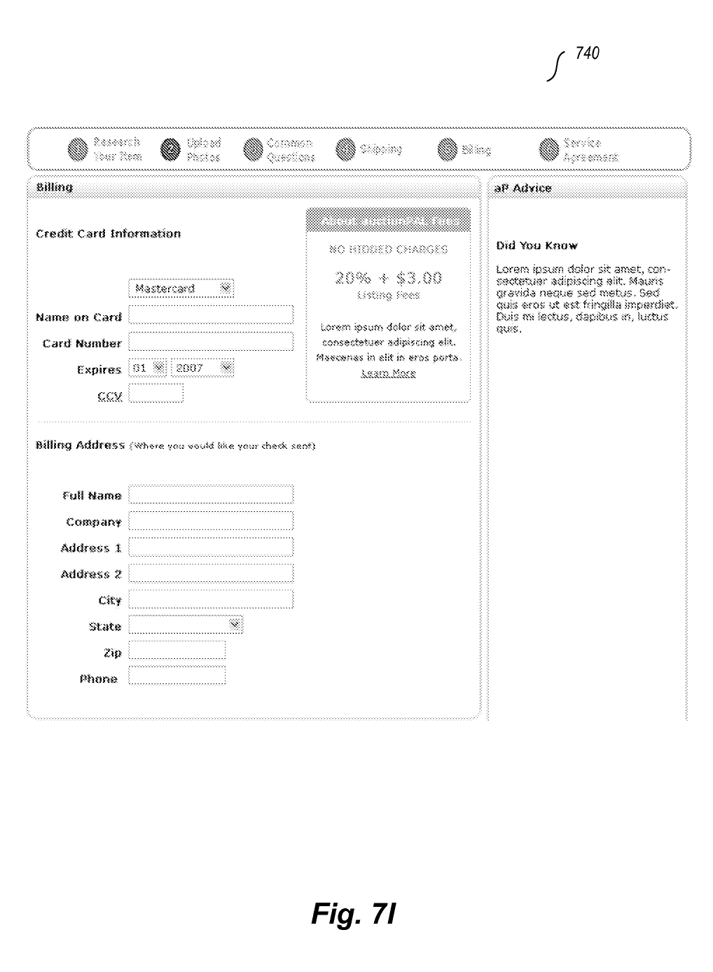

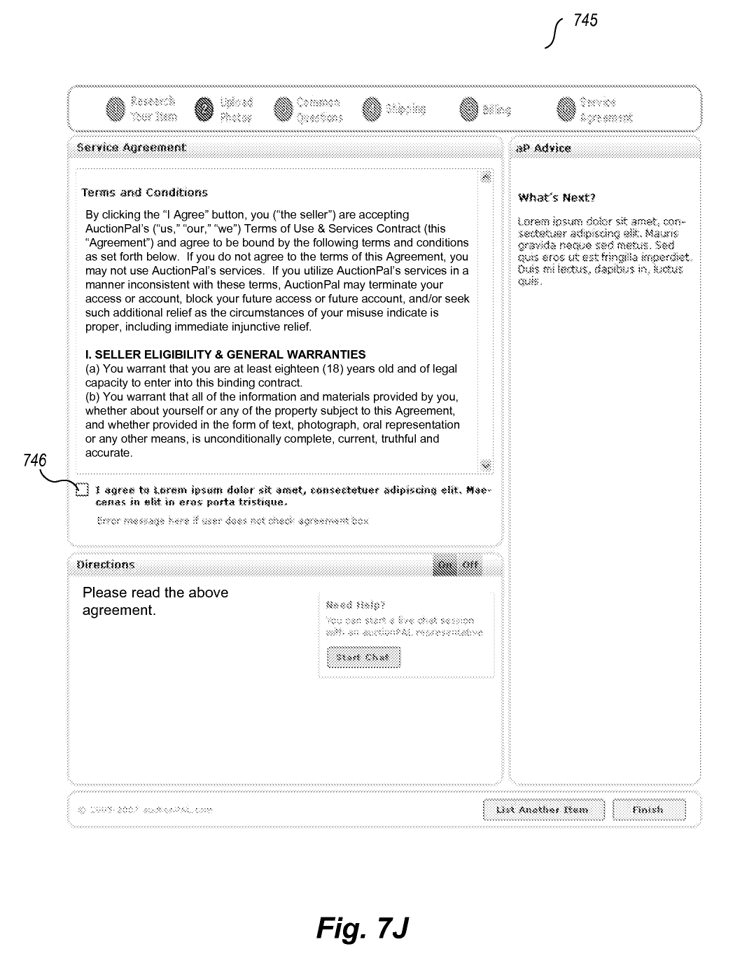

FIG. 2 also illustrates at least three models with which sellers can sell items via the EFE 200. First, in a “self service” sales model, seller 212 utilizes the seller client device 206 to interact with the EFS 201 to provide information about an item for sale. The seller client device 206 may be any computing system configured to provide a user interface for interacting with the EFS 201, including desktop, laptop, or mobile computing devices operating Web browsers or other environments (e.g., operating systems, runtime systems, etc.) configured to execute client applications and/or interfaces. The EFS 201 utilizes the obtained information to list the item on one or more of the third-party item exchange systems 220. The seller 212 then utilizes the seller client device 206 to receive updates about progress of the sale, and to receive a notification a completed sale, possibly including instructions for shipping the sold item to the buyer 214 who purchased the item. In this model, the seller 212 need not interact with any human operators, assistants, or agents to sell an item via the EFS 201. Users who utilize the self service sales model may be provided with a discounted rate for using the EFS 201, due to the lower overheads and minimal human intervention utilized to facilitate the sale. An example user interface and functionality provided by the self service sales model are described with reference to FIGS. 7A-7K, below.

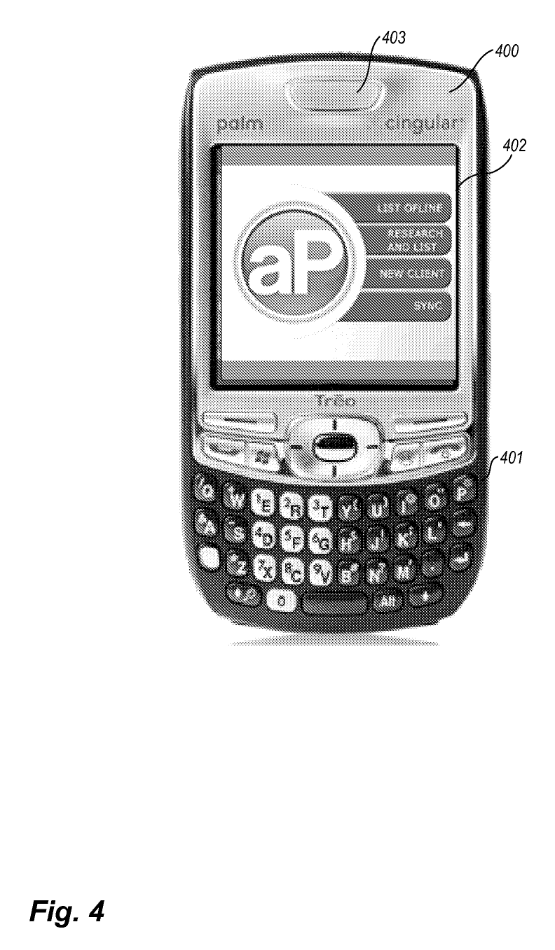

Second, in an “local agent assisted” sales model, the local agent 211 (also referred to as a “hunter”) interacts with seller 210 to obtain information about an item for sale. The local agent 211, in turn, interacts with the local agent client device 207 to provide the obtained information to the EFS 201. The local agent client device 207 may typically be a mobile computing device, such that the agent 211 can conveniently transport the device to a site associated with the seller 210 (e.g., their home, business, office, etc.). As described with reference to the self service sales model, above, the EFS 201 utilizes the obtained information to facilitate the sale of the item on one or more of the third-party item exchange systems 220. In the local agent assisted sales model, local agents may be compensated by the EFS 201 for every item they list and/or eventually sell on behalf of a seller at other times. The local agents may be employees of the owner/operator of the EFS 201, contractors, franchisees, etc. Accordingly, such a sales model may increase the intake of items being sold via the EFS 201, thereby increasing revenues and/or profits obtained by the EFS 201. In addition, by interacting with a local agent, a seller lacking the experience, skills, or capabilities needed to list an item on their own, may sell items via the EFS 201 that otherwise may have gone unsold. An example local agent client device and an example user interface provided by such a device are described with reference to FIGS. 4, 5, and 6A-6O, below.

Third, in a “remote agent assisted” sales model, seller 212 utilizes the seller client device 206 to interact with remote agent 213 via the EFS 201 to provide information about an item for sale. In this model, the remote agent 213 may provide various forms of assistance to the seller 212 to facilitate the intake of an item offered for sale. For example, the remote agent 213 may utilize the remote agent client device 208 to conference with the seller 212 in order to obtain information about the item being offered for sale, such that the remote agent 213 and/or the EFS 201 may generate an effective listing for one or more of the third-party item exchange systems 220. The remote agent client device 208 may be a computing system that provides chat or other messaging capability. In other embodiments, the remote agent client device 208 may be a telephone or other type of communications device.

In addition, the remote agent assisted sales model may facilitate the intake of items from sellers that do not possess or can not conveniently access a seller client device 206 that is capable of, or configured to, provide at least some of the features or functions used by the self service sales model. For example, if the seller client device 206 is a camera phone with limited display and/or computing capabilities, the seller 212 may still take a photo of an item offered for sale, and send the photo (e.g., via picture message, email, etc.) to the EFS 201. Once the photo is received by the EFS 201, the EFS 201 may pass the received information on to a remote agent 213, who may then initiate a conference (e.g., by placing a telephone call) with the seller 212 to obtain additional information about the item offered for sale. As such, the remote agent assisted sales model may increase item intake by the EFS 201 by making its functionality available to users who do not have the time, client computing devices, capabilities, or skills to sell an item using the self service sales model.

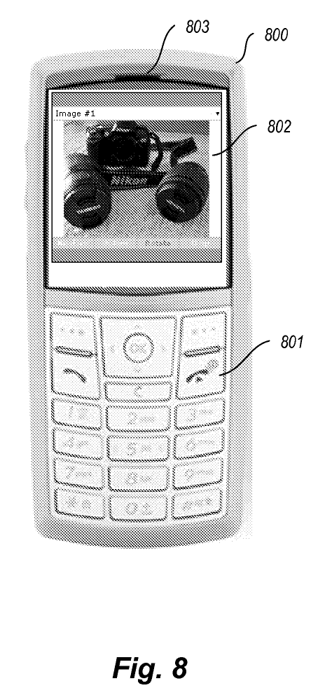

In addition, remote agents may provide domain expertise related to the sale of particular types or categories of items. For example, a first remote agent may be an expert in baseball memorabilia whereas a second remote agent may be an expert in consumer electronic devices. Or, for example, a remote agent may be an expert in a particular item exchange system, such as eBay® auctions, Sotheby's auctions, Kelly Blue Book® auto sales, etc. In some embodiments, the EFS 201 may automatically match sellers with remote agents based on factors such as the type of item being sold, agents' areas of expertise, seller's technical sophistication, etc. Furthermore, various types of employment relationships between remote agents and the operator of the EFS may exist. For example, remote agents may be compensated as full or part time employees, as independent contractors, on a commission basis, franchisees, etc. An example seller client device client device and an example user interface and functionality provided by a remote agent client device are described with reference to FIGS. 8, 9, and 10A-10J, below.

The various sales models described above are not exclusive of one another in their operation, functionality, or techniques. Techniques and features described with respect to one model may be employed in the context of other models as well. For example, in some cases, a local agent may utilize the assistance of a remote agent in order to facilitate a particular transaction (e.g., to obtain or provide information that is not readily available or accessible via the client device utilized by the local agent), or to provide expertise to the local agent.

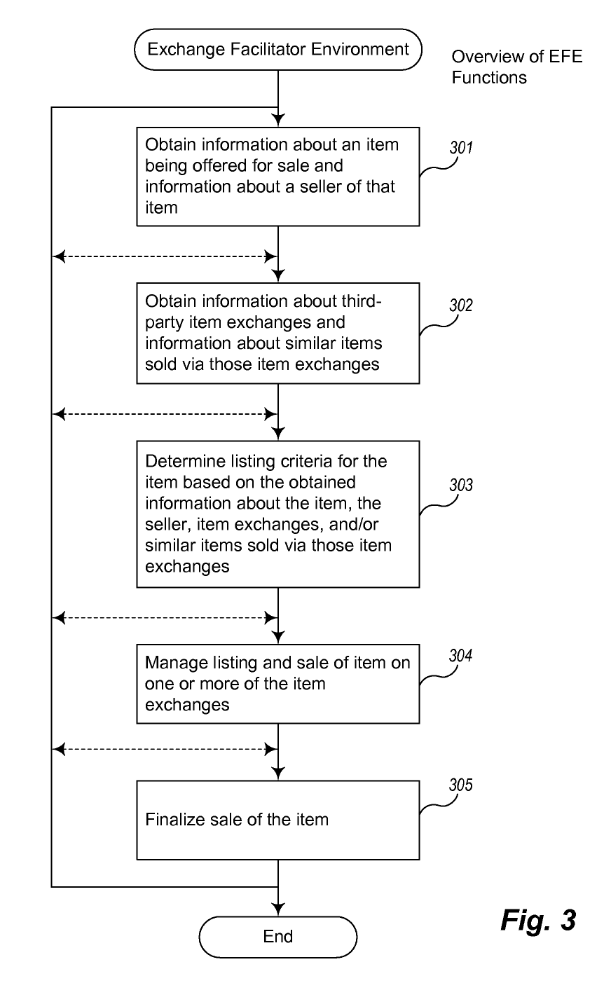

FIG. 3 is an example overview flow diagram of example functions provided by an example embodiment of an Exchange Facilitator Environment. Such functions may be provided by, for example, the EFE 200 described with reference to FIG. 2, above. Although the illustrated functions are presented in a particular order, in other embodiments they may be executed in other orders and/or concurrently or asynchronously. The dashed lines indicate that after performing a particular function, any other illustrated function may be next performed by the Exchange Facilitator Environment. Other embodiments may provide additional functions or alternatively provide fewer functions.

In step 301, the environment obtains information about an item being offered for sale and information about a seller of that item. Such information may be obtained via, for example, the item listing management engine 203 and client devices 206-208 described with reference to FIG. 2. Obtained information may be stored in the EFS data repository 205. The obtained information about the item may include a textual description of the item, an image of the item, a category associated with the item, etc. The obtained information about the seller may include an address associated with the seller, the seller's preferred payment mechanism, a customer identifier associated with the seller, etc.

In step 302, the environment obtains information about third-party item exchanges and information about similar items sold via those item exchanges. Such a function may be provided by, for example, the item listing criteria optimization engine 202 described with reference to FIG. 2. The obtained information may be stored in the EFS data repository 205. The obtained information may include transaction records of item sales on the third-party item exchanges, including listing duration and/or timing (e.g., length of sale), sales outcomes (e.g., final sales price), listing details (e.g., text and/or images used to describe an item), etc.

In step 303, the environment determines listing criteria for the item being offered for sale based on, for example, the obtained information about the item, the seller of the item, the third-party item exchanges, and/or similar items sold via those item exchanges. Such a function may be provided by, for example, the item listing management engine 203 and/or the item listing criteria optimization engine 204 described with reference to FIG. 2.

In step 304, the environment manages the listing and sale of the item on one or more of the third-party item exchanges. This may include automatically generating an item listing based on determined item listing criteria, providing the generated item listing to the one or more third-party item exchanges, providing notifications to the seller regarding the status of the item listing (e.g., current bid price, quantity sold, etc.). Such a function may be provided by, for example, the item listing management engine 203 described with reference to FIG. 2.

In step 305, the environment finalizes sale of the item by, for example, initiating the sending of shipping materials to the seller, such that the seller can send the item to the buyer of the item. Such a function may be provided by, for example, the item listing management engine 203 described with reference to FIG. 2.

For illustrative purposes, some embodiments are described below in which specific types of techniques, implementations, computing systems, and information technologies are presented, discussed, and/or utilized. These examples are provided for illustrative purposes and are simplified for the sake of brevity. The techniques can also be used in a wide variety of other situations, some of which are discussed below, and are not limited to use with facilitating item exchanges via third-party item exchange systems. For example, such techniques can be used to facilitate item purchases by buyers, provide market information to market analysts, etc.

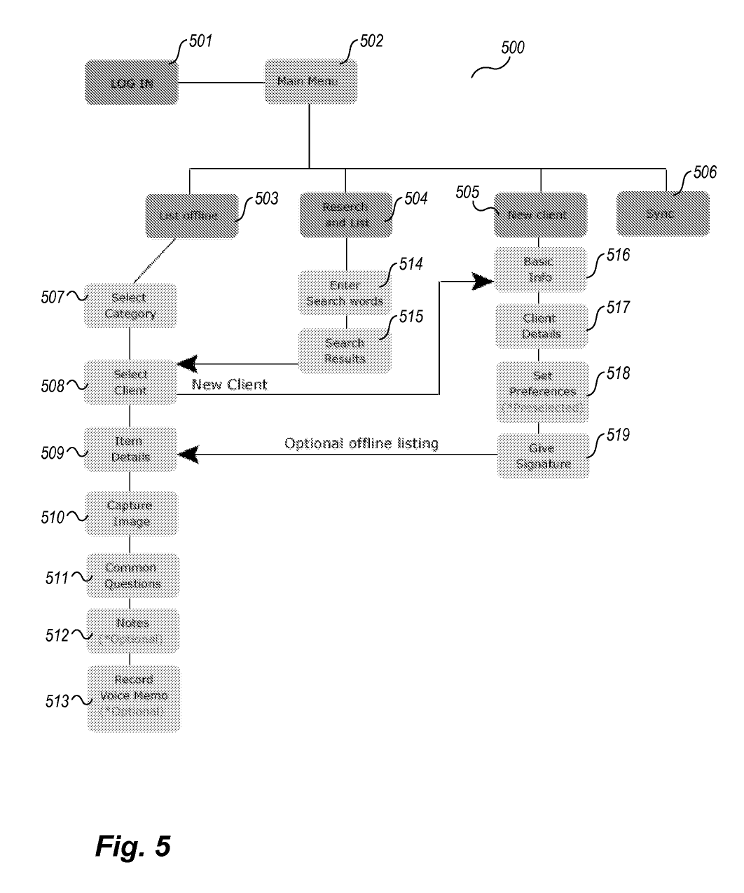

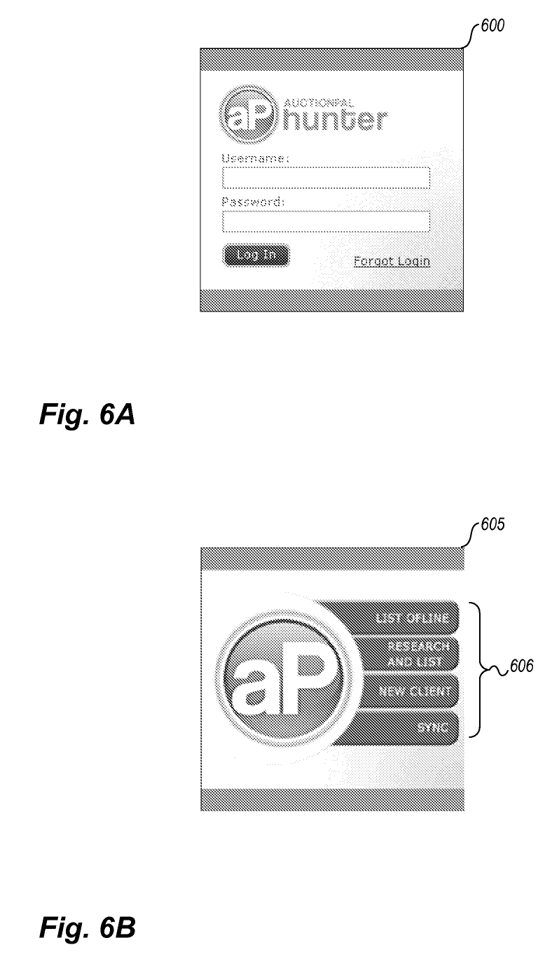

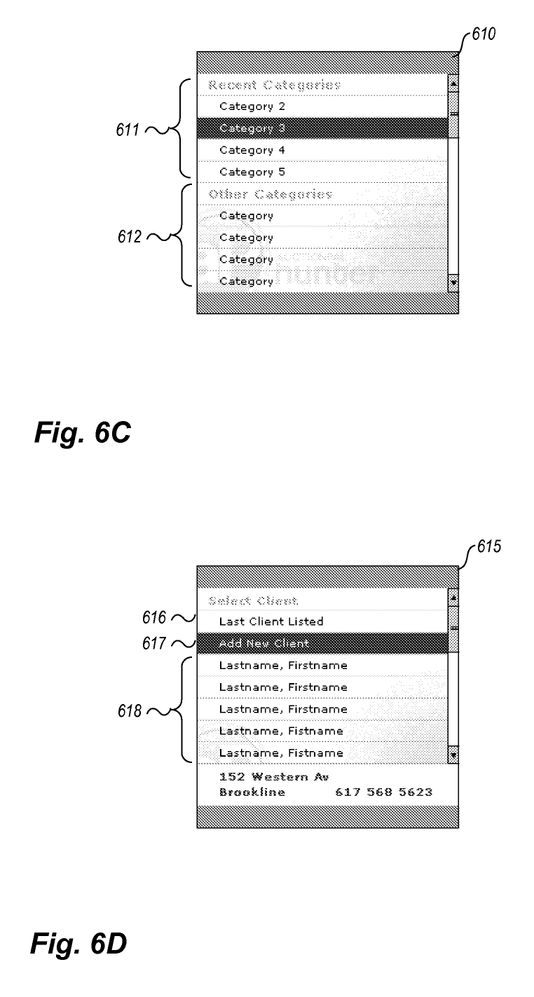

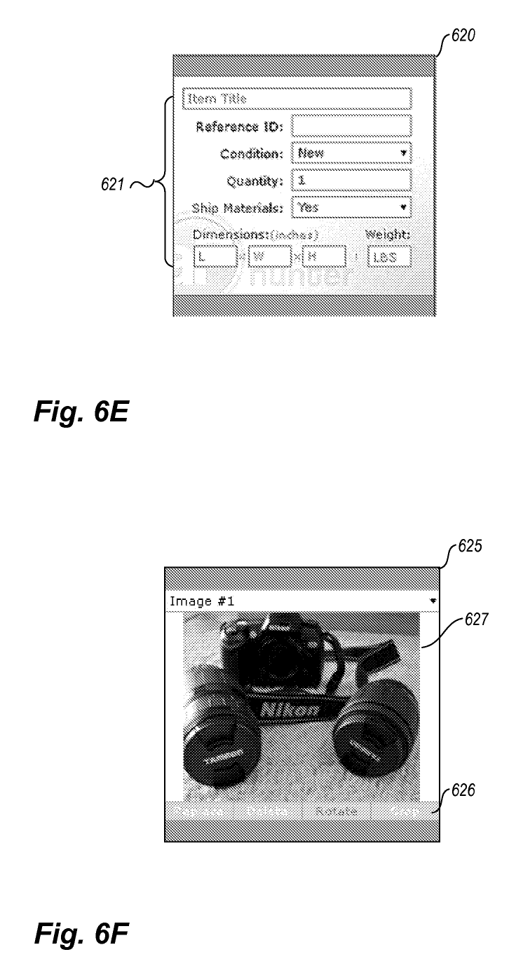

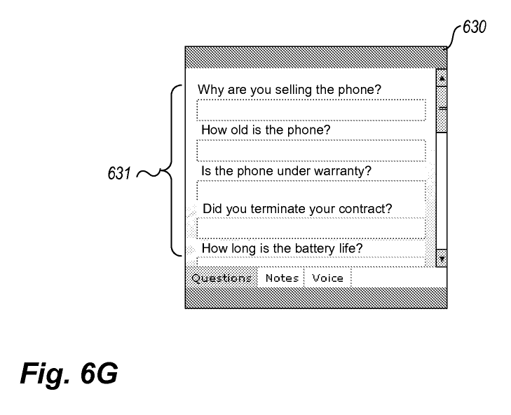

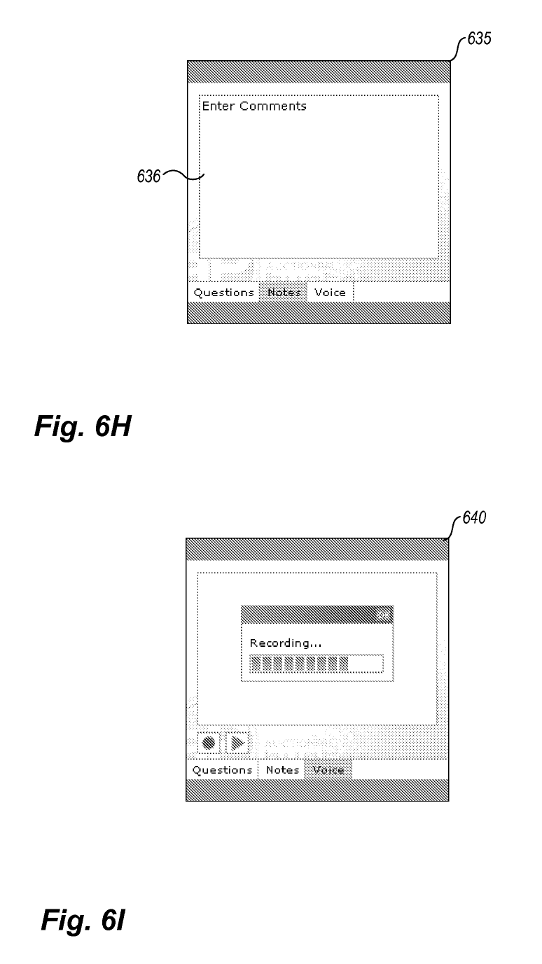

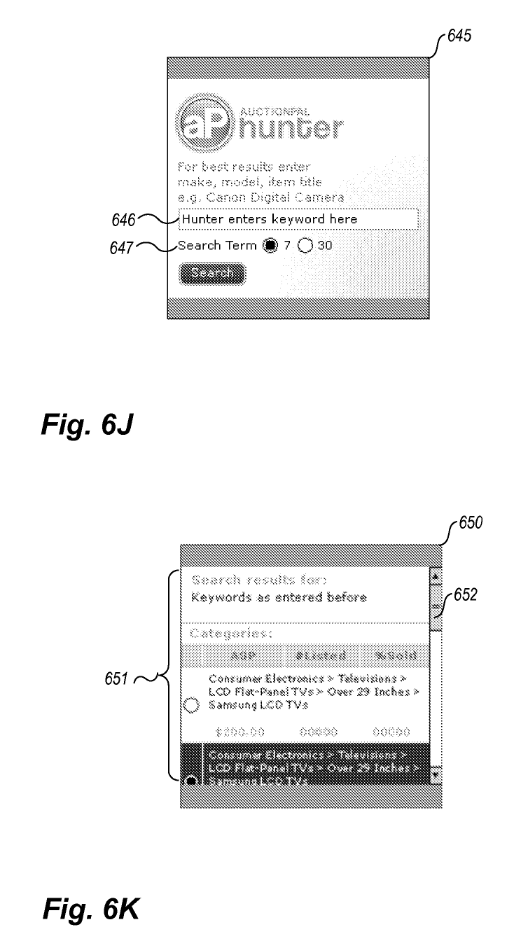

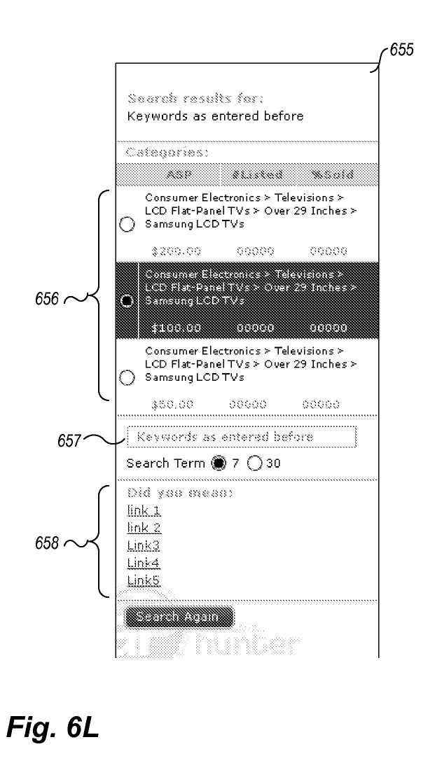

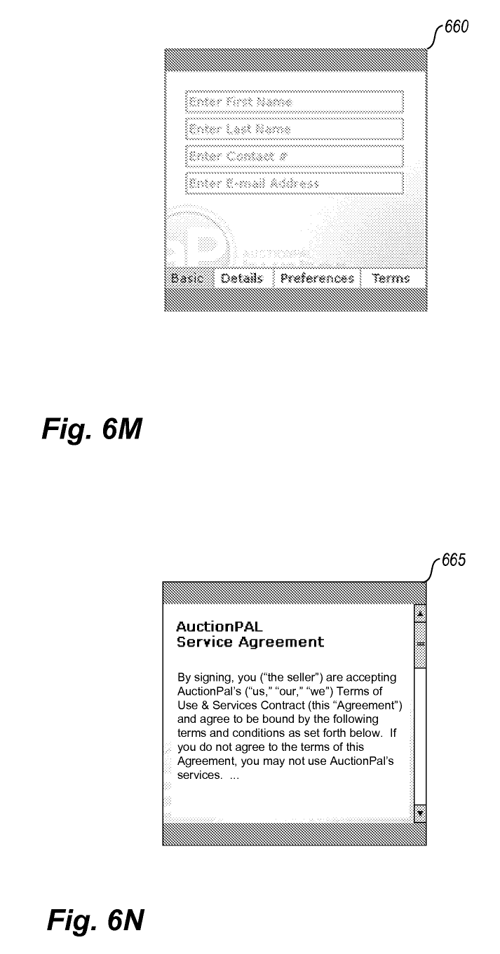

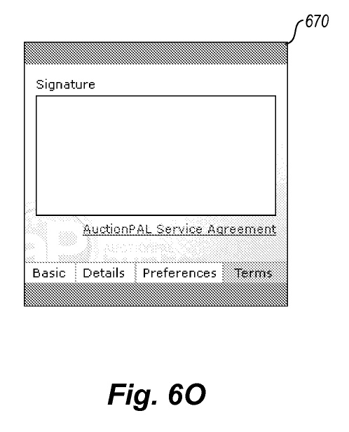

FIG. 4 illustrates an example mobile computing device configured to execute an example local agent client application. The illustrated mobile computing device may be, for example, utilized by a local agent in the context of the “local agent assisted” sales model described with reference to FIG. 2, above. In particular, FIG. 4 shows a mobile computing device (a “smart phone”) 400 comprising a keypad 401, a screen 402, a speaker 403, a microphone (not shown), a camera (not shown), as well as other input/output, storage, and computation devices (not shown). In addition, the mobile computing device 400 is configured to place and receive telephone calls and connect, in a wired or wireless manner, to other computing systems via public (e.g., the Internet) and/or private networks. Various types of mobile computing devices may be utilized, including laptop computers, personal digital assistants (“PDAs”), cell phones, etc. In the illustrated example, the display screen 402 is presenting a menu screen for a local agent client application executing on the mobile computing device 400, such as will be described in more detail with reference to FIGS. 5 and 6A-6O, below. A local agent may utilize the illustrated mobile computing device 400 to interact with an EFS, in order to provide information related to items being sold on behalf of sellers.

FIG. 5 is an example block diagram illustrating control flow between screens displayed by an example local agent client application. In particular, FIG. 5 shows a graph 500 of multiple nodes 501-519 that each represent a function or action provided by a screen of the example local agent client application. In a typical interaction, an agent begins with a login screen 501. After logging in, a main menu screen 502 is displayed, which provides controls (e.g., buttons, links, options, etc.) for displaying screens 503-506 for listing a new item, researching an item, adding a new client, and synchronizing the application with the EFS, respectively.

When the agent decides to list a new item, a sequence of screens 507-513 is presented, with which the agent may provide information about an item to be listed for sale. In screen 507, the agent selects a category for the item. In screen 508, the agent selects a current client. If the seller is not an existing client, the agent may transfer to another sequence of screens 516-519 that may be utilized to enter new client information, as described below. In screens 509-513, the agent may enter item information about the item, capture an image of the item, respond to one or more common questions about the item, enter notes about the item, and record a voice memo about the item, respectively.

When the agent decides to research an item, a sequence of screens 514-515 is presented, with which the agent may obtain information about an item to be listed for sale. In screen 514, the agent may enter search criteria. In screen 515, results based on the entered search criteria are displayed. Search results may include information about similar or identical items sold on various third-party exchanges, such that the agent can obtain information about the item (e.g., the likely value of an item, typical item descriptions, etc.). From screen 515, the agent may transfer to the sequence of screens 508-513 to provide information about a seller and an item to be listed for sale, as described above.

When the agent decides to add a new client, a sequence of screens 516-519 is presented, with which the agent may provide information about a seller of an item. In screen 516-519, the agent may respectively enter basic information about the new client (e.g., name and address), enter client details (e.g., payment information), set client preferences (e.g., preferred payment options, preferred contact mechanism, etc.), and obtain the signature or assent of the new client (e.g., indicating an agreement to allow the agent to sell the item on behalf of the seller, indicating that the seller has read and/or understood the terms and conditions of utilizing the EFS and/or the services of the agent, etc.). After screen 519, the agent may transfer to the sequence of screens 509-513 to provide information about an item to be listed for sale, as described above.

When the agent decides to synchronize the application via screen 506, information about clients and/or items provided by the agent to the client application since the last synchronization event is uploaded or otherwise transmitted, forwarded, or sent to the EFS. In addition, information may be downloaded from the EFS to the client application, reflecting changes in the state or other information managed by the EFS that may be of interest to the agent (e.g., items listed by the agent that have sold since the last synchronization event, etc.). While synchronization is initiated manually in the illustrated embodiment, other synchronization techniques are contemplated, such as automatic synchronization after particular events (e.g., entry of a new item, creation of a new client account, on a periodic basis, etc.).

FIGS. 6A-6O are example screen displays provided by an example local agent client application. In particular, FIGS. 6A-6O illustrate screen displays that are similar to, or correspond with, screens and/or functions discussed with reference to FIG. 5, above. By utilizing the functions provided by the illustrated screens, an agent can provide information to the EFS about items being offered for sale by sellers, and perform other functions related to the facilitation of item exchanges.

FIG. 6A illustrates a login screen 600 that may be utilized to authenticate an agent to the EFS and/or the local agent client application. FIG. 6B illustrates a main menu screen 605 that provides controls (e.g., buttons) 606 that may be selected by the agent to access various functions of the local agent client application.

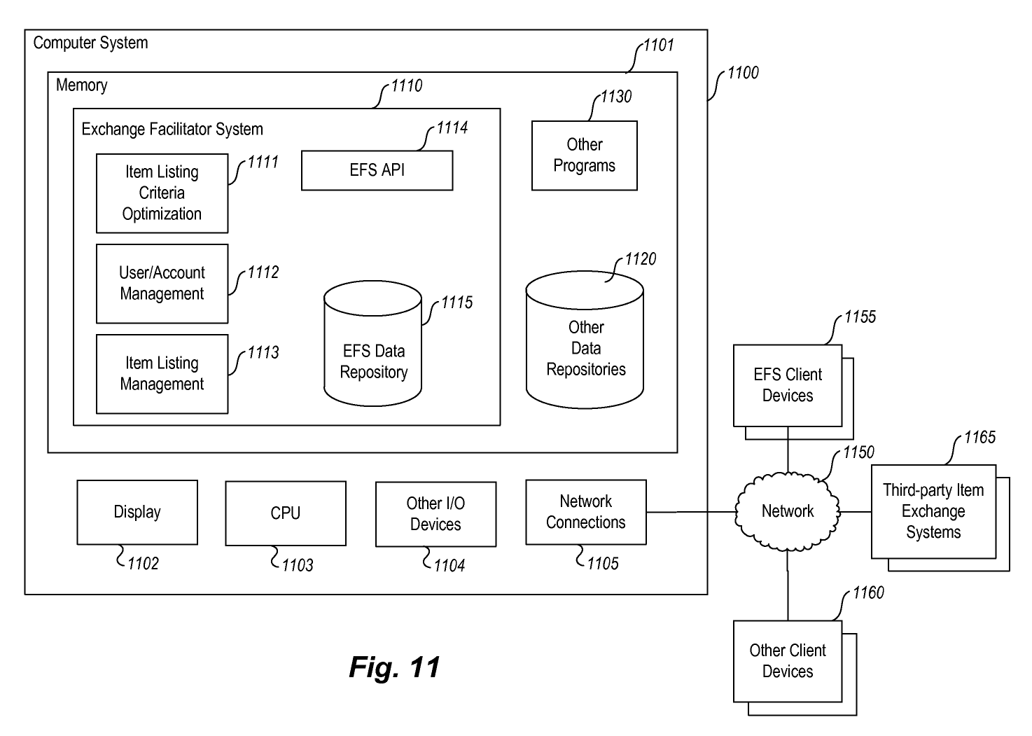

FIGS. 6C-6I depict screens that provide functionality for providing information about an item for sale. In particular, FIG. 6C illustrates a category selection screen 610 that includes menu of recently accessed item categories 611 and a menu of other categories 612. In the illustrated embodiment, items are each associated with one or more categories (e.g., consumer electronics, sporting equipment, computing devices, vehicles, office equipment, etc.), such that they may be conveniently browsed and otherwise organized. In addition, the associated categories may be utilized to organize or select associated item listing criteria and/or common questions related to specific items. FIG. 6D illustrates a client selection screen 615 that provides a control for accessing the most recently listed client 616, a control for adding a new client 617, and a menu of all clients associated with the agent 618. FIG. 6E illustrates an item details screen 620 that includes controls 621 for entering information such as item title, item condition, quantity for sale, whether the client requests shipping materials, item dimensions, and item weight. FIG. 6F illustrates an image capture screen 625 that includes controls 626 for modifying and/or manipulating an image 627 captured by a camera or other image capture device (e.g., a scanner) associated with the client application. FIG. 6G illustrates a common questions screen 630 that includes a menu of common questions 631 about the item being listed for sale. The presented list of common questions may be based on the category, type, or identity of the item as determined by initial information entered about the item, such as via the item details screen 620. FIG. 6H illustrates a notes screen 635 that includes a text entry control 636 with which the agent may enter additional comments regarding the item being listed for sale. Some comments when received may be used by the EFS to gather “intelligence” for a common questions data repository, such as the EFS data repository 1115, described with reference to FIG. 11, below. FIG. 6I illustrates a voice recording screen 640, with which the agent may record a voice memo or other dictation about the item being listed for sale. In some embodiments, the dictation may be automatically translated to text (e.g., via a speech recognition engine) by the client application and/or the EFS.

FIGS. 6J-6L depict screens that provide functionality for researching items being listed for sale. In particular, FIG. 6J illustrates a search criteria entry screen 645 that includes a text input control 646 and a search date restriction control 647. The agent may use the text input control 646 to enter search terms, tags, and/or keywords for items managed by the EFS and/or sold by various third-party item exchanges. The agent may additionally restrict the search by time, by using control 647 to specify whether the search should return results about items matching the search query that sold within the last seven or thirty days. In other embodiments, other controls for specifying search criteria may be included, including controls that provide other time intervals and other filtering capabilities. FIG. 6K illustrates a search results screen 650 showing a menu of search results 651 that match the criteria provided via screen 645, above. Because the menu of search results 651 may be longer than the display provided by the client application and/or device, a slider control 652 is provided to access other portions of the search results. FIG. 6L illustrates an expanded view of a search results menu 655, such as the one discussed with respect to FIG. 6K, above. The menu 655 includes a results section 656, a search control 657 populated with keywords and other criteria utilized to obtain the presented search results, and an disambiguation menu 658. The disambiguation menu 658 may be utilized to present other search results based on alternate spellings, related categories of items, etc.

FIGS. 6M-6O depict screens that provide functionality for adding a new client. In particular, FIG. 6M illustrates a client details screen 660 that may be utilized by the agent to enter information about a new client. FIG. 6N includes a terms and conditions screen 665 that may be utilized to display a service agreement to a new client. FIG. 6O includes a signature screen 670 that may be utilized by a new client to manifest assent to the service agreement displayed via screen 665. In the illustrated embodiment, the new client may provide a signature via stylus device. In other embodiments, the new client may manifest assent in other ways, such as selecting a control (e.g., pressing a button, checking a box, etc.), recording a voice message in which they provide oral assent, etc.

Although the above techniques are described with respect to a client application and device utilized by a local agent, they may be employed in other contexts and for other kinds of users as well. For example, at least some of the aspects of the local agent client application above may be provided in an application used by sellers and/or remote agents, or on different kinds of computing devices (e.g., desktop computing systems).

FIGS. 7A-7J are example screen displays provided by an example seller client application. In particular, FIGS. 7A-7J depict screen displays provided by a seller client application (e.g., a Web browser) executing on, for example, seller client device 206 described with reference to FIG. 2. The illustrated screen displays may be utilized in the context of the “self service” sales model described with reference to FIG. 2, above. By utilizing functions provided by the illustrated screens, a seller may access various functions provided by the EFS.

FIGS. 7A-7B depict screens that provide seller login and/or registration functionality. In particular, FIG. 7A illustrates a login screen 700 that may be utilized to authenticate sellers that have existing accounts with the EFS. FIG. 7B illustrates a registration screen 705 that may be utilized by a seller to create a new account with the EFS.

FIGS. 7C-7D depict screens that provide functionality for researching an item. In particular, FIG. 7C illustrates a search screen 710 that may be used by a seller to obtain information about items being sold via the EFS. A seller may choose to utilize such a screen to determine the value of an item they wish to sell. The search screen 710 includes a context indicator 711 that provides the seller with an indication of their progress through a sequence of phases related to listing an item for sale. The search screen 710 also includes a search input control 712. The search input control 712 also provides suggested search terms 713 that are based on initial search terms provided by the seller. In this manner, the seller may select search terms that more accurately describe the item they are selling, so as to obtain more targeted search results. Suggested search terms may be determined by the EFS in various ways, such as by leveraging a knowledge base and/or item taxonomy that includes common misspellings, keywords, tags, associated and/or related item categories, etc. Such a knowledge base or item taxonomy may be generated and/or maintained by the EFS, based on human input and/or machine intelligence. In addition, such a knowledge base may include and/or refer to additional information about items, such as template item listings, item descriptions, stock photos, common questions, etc.

FIG. 7D illustrates a search results screen 715 that includes a search results list 716, an instructions control 717, a chat control 718, and an advice control 719. The search results list 716 includes multiple items and/or categories matching search criteria provided by the seller. In addition, for each listed item, an average selling price, a success rate (e.g., percentage of items listed that eventually sold), and a number listed and/or sold (e.g., the number of active listings for the item). The instructions control 717 provides information about the item listing process, and may be updated automatically based on user inputs and/or progress through the listing process. The chat control 718 may be selected by the seller to initiate a conference (e.g., an online chat) with an agent associated with the EFS, such as remote agent 213 described with reference to FIG. 2. The advice control 719 may include various, possibly context-specific, information to the seller. In the illustrated example, a “hot list” showing images of popular items is displayed, each of which may be selected by a user to bypass the normal search process in order to directly obtain information about each listed item.

FIGS. 7E-7F depict screens that provide functionality for uploading photos of an item being sold by a seller. In particular, FIG. 7E illustrates a photo upload screen 720 that includes an file selection control 721 that may be utilized by a seller to identify and/or select one or more item photos to upload to the EFS. FIG. 7F illustrates an alternative photo upload screen 725 that includes a “drag-and-drop” control 726 that may be utilized by a seller to directly provide (e.g., by dragging an photo from another application) and preview one or more item photos to upload to the EFS. In other embodiments, photos may be uploaded in other ways, such as by using a button or other user interface control installed on a Web browser (e.g., as a browser add-on, applet, favelet, bookmarklet, etc.) that allows a seller to initiate transmission of a photo (e.g., being viewed on a current Web page) to their EFS account with a single action (e.g., a mouse click).

FIG. 7G illustrates an item details screen 730 that provides functionality for forwarding to the EFS details about an item being offered for sale. Screen 730 includes an item information control 731 that includes controls with which a user may specify an item title, an item condition, an item quantity, and comments about the item. In addition, the item information control 731 includes a list of common questions 732 that is customized based on the type of item being offered for sale and, potentially, other related information known by the EFS, such as related items and/or item categories, the geographic location of the item, etc. In some embodiments, the EFS may automatically generate an item listing based on the information provided by the seller via this and/or other screens. For instance, in the illustrated example, the seller is offering a “Brand X” bicycle for sale, and the list of common questions 732 correspondingly includes questions related to bicycles.

FIG. 7H illustrates a shipping details screen 735 that a seller may use to provide information related to shipping an item. In particular, the seller may utilize screen 735 to indicate that they wish to receive shipping materials from the EFS, and if so, provide details related to the size and weight of the item along with a shipping address. Using the provided information, the EFS can send shipping materials to the seller, such that the seller may conveniently send a sold item to a buyer.

FIG. 7I illustrates a payment details screen 740 that may be utilized by the seller to specify billing and/or payment mechanisms and other information. Various payment mechanisms may be supported and/or provided. In some embodiments, payment may instead or in addition be made by providing store credit (e.g., for shopping at an affiliated merchant), gift cards, points (e.g., that may later be redeemed for other items), etc.

FIG. 7J illustrates a service agreement screen 745 that includes a control 746 that a seller may select to manifest assent to the terms and conditions of a service agreement with the EFS (e.g., describing or specifying commissions, warranties, indemnification terms, dispute resolution clauses, etc.).

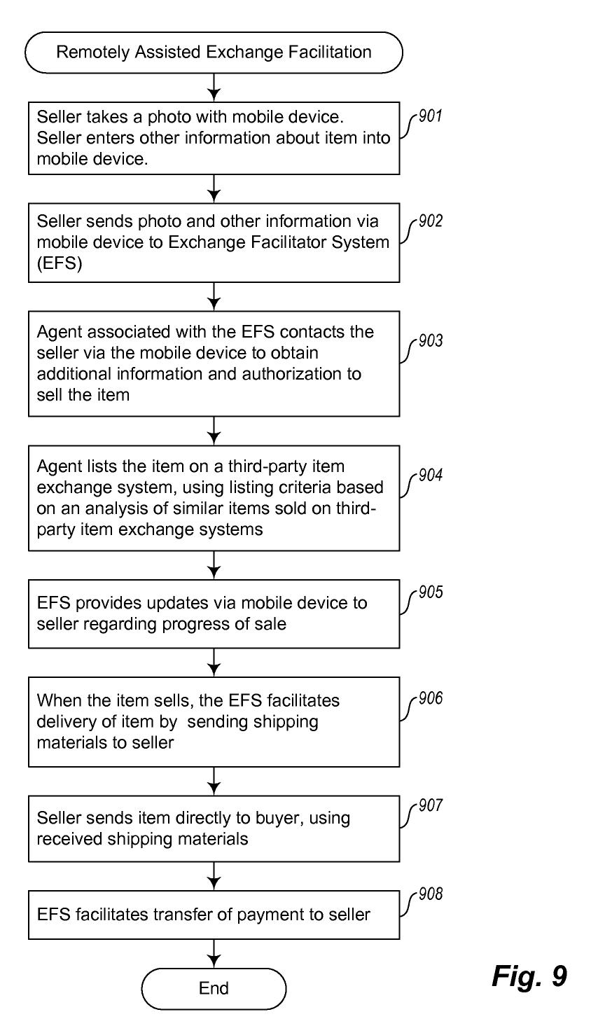

FIG. 8 illustrates an example mobile phone configured to operate as an example seller client device. In particular, the example mobile phone may be utilized by a seller to engage in the “remote agent assisted” sales model described with reference to FIG. 2, above. FIG. 8 shows a mobile phone 800 comprising a keypad 801, a screen 802, a speaker 403, a microphone (not shown), a camera (not shown), as well as other input/output, storage, and computation devices (not shown). The mobile phone 800 is configured to place and receive telephone calls in a wireless manner (e.g., using a cellular telephone network). The mobile phone 800 may be utilized by a seller to engage a remote agent assisted item exchange, as described in additional detail with reference to FIG. 9, below. As noted above, such a sales model supports the use of limited-functionality client devices, such as camera phones that do not provide sufficient computing capacity or network connectivity to execute a more fully featured client application.

FIG. 9 is an example flow diagram of an example remotely assisted exchange facilitation process. The illustrated process describes at least some of the steps or actions taken by a seller utilizing a camera phone or other client device to provide information about an item being offered for sale and to conference with a remote agent in order to provide additional information, such as may occur in a remote agent assisted sales model. The process may be provided by interactions between, and actions of, various components of an Exchange Facilitator Environment, as described with reference to FIG. 2.

More specifically in step 901, a seller takes a photo with a mobile device (e.g., a camera phone) and enters other information (e.g., by composing a text message) about the item into the mobile device (e.g., an item description or title). In step 902, the seller sends the photo and other information via the mobile device to the EFS by, for example, sending a text message (e.g., a Short Message Service message), picture message, multimedia message (e.g., a Multimedia Messaging Service message), email (e.g., a Simple Mail Transfer Protocol message), etc. In step 903, an agent associated with the EFS contacts the seller via the mobile device (e.g., by placing a telephone call to the camera phone operated by the seller) to obtain additional information about the item and the seller (e.g., preferred payment mechanism, shipping address, etc.), and to obtain authorization to sell the item via the EFS. In other embodiments, a seller may specify (e.g., along with photo and other information) a preferred conference time, in which case step 903 may be delayed until the specified time. In step 904, the agent lists the item on a third-party item exchange system, using listing criteria that are based on an analysis of items sold on various third-party item exchange systems. As described in more detail elsewhere, the listing criteria may be automatically generated by the EFS and/or manually composed by the agent with the assistance of the EFS. In step 905, the EFS provides updates via the mobile device (e.g., by sending voice messages, text messages, etc.) to the seller regarding the progress of the sale of their item. In step 906, when and if the item sells, the EFS may facilitate delivery of the item by sending shipping materials to the seller. In step 907, the seller sends the item directly to the buyer, using, if available, the received shipping materials. In step 908, the EFS facilitates the transfer of payment to the seller by, for example, initiating an electronic funds transfer to a bank account held by the seller, based on payment preferences provided by the seller in step 903, above.

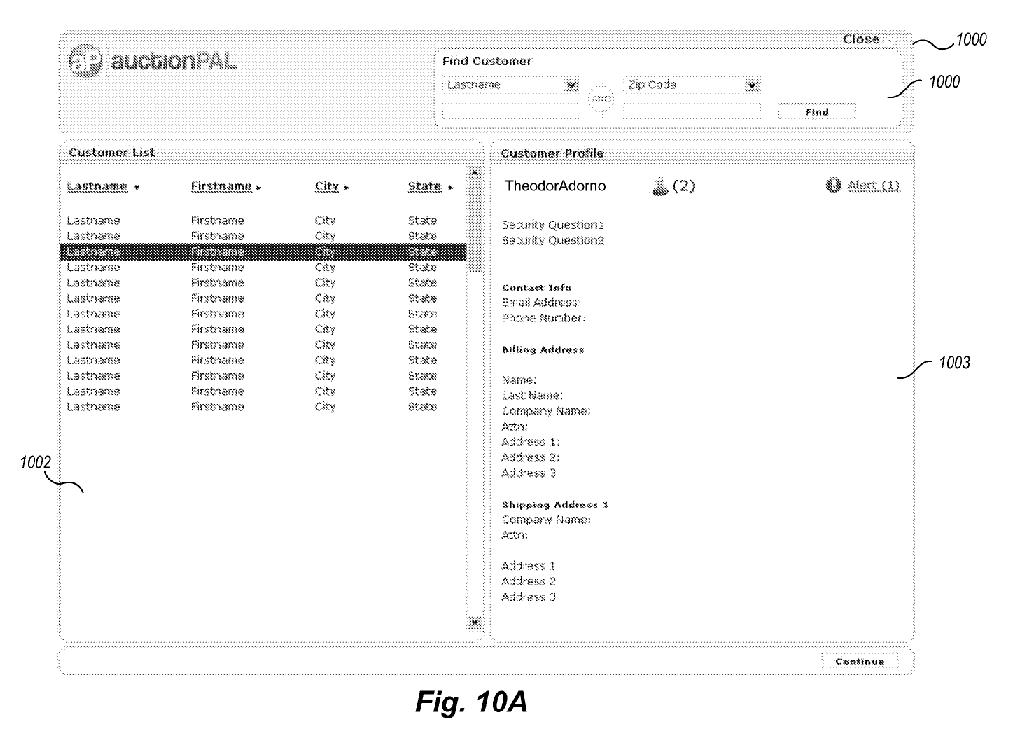

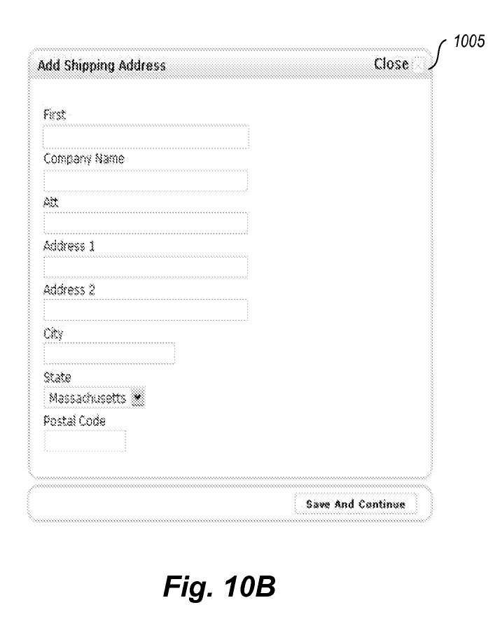

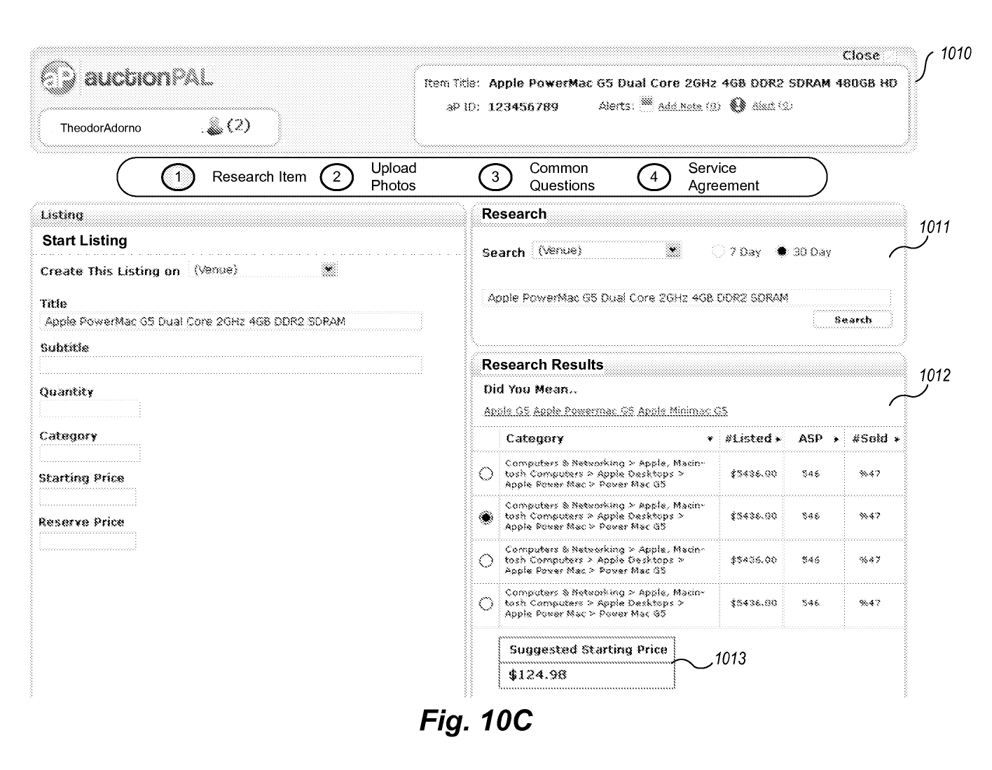

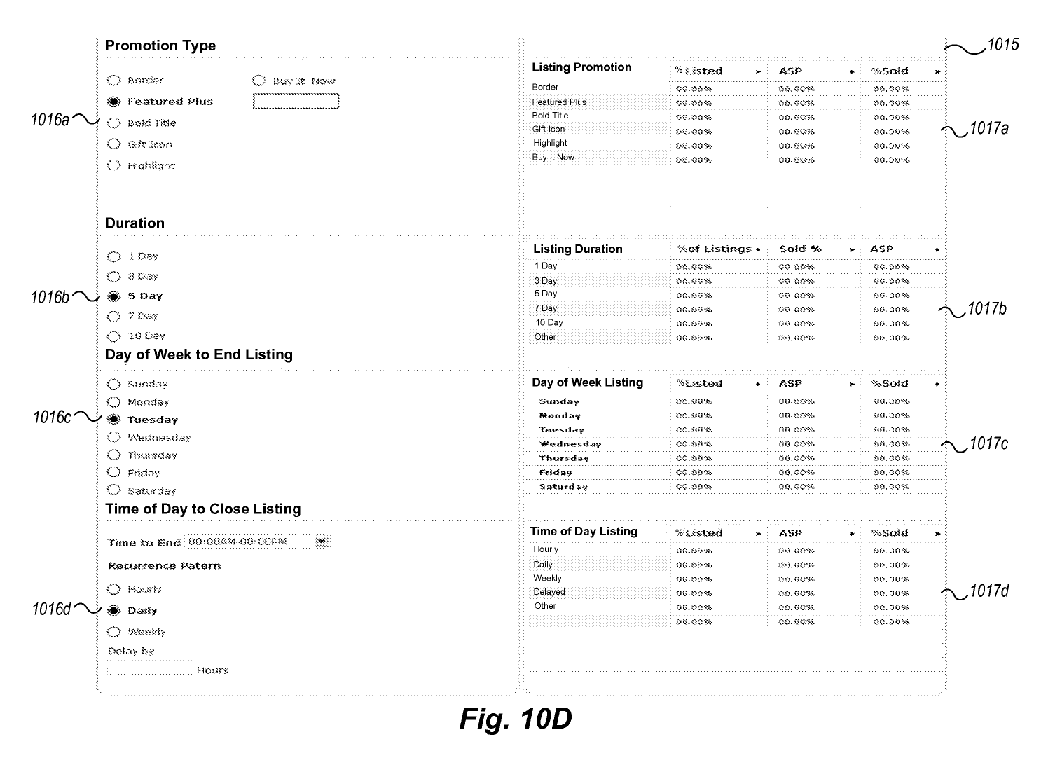

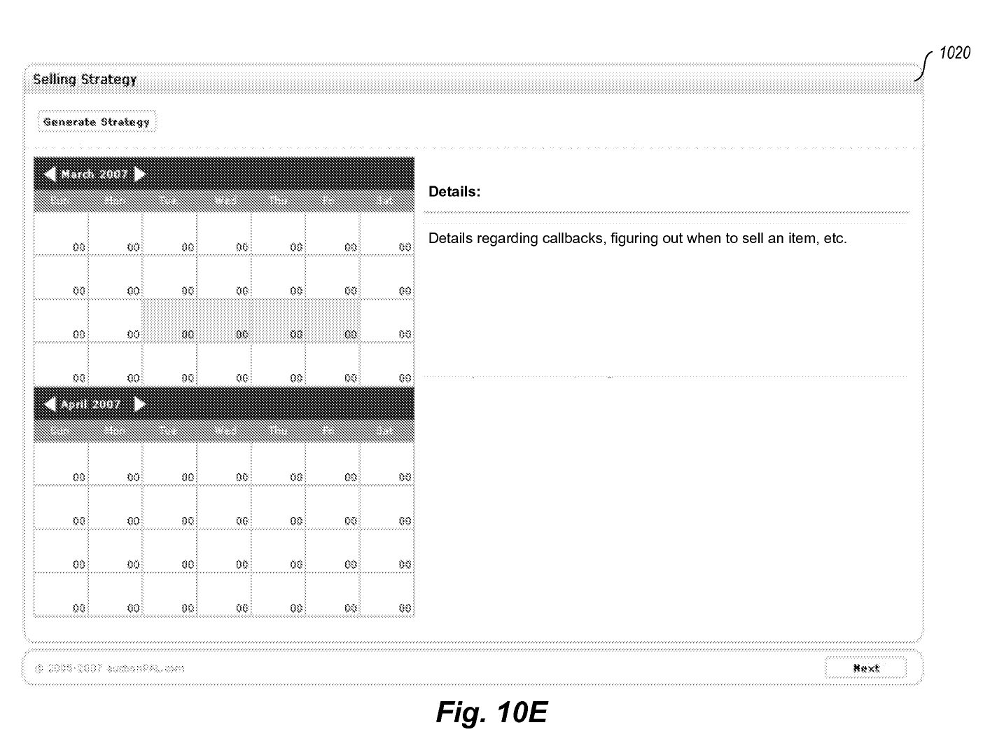

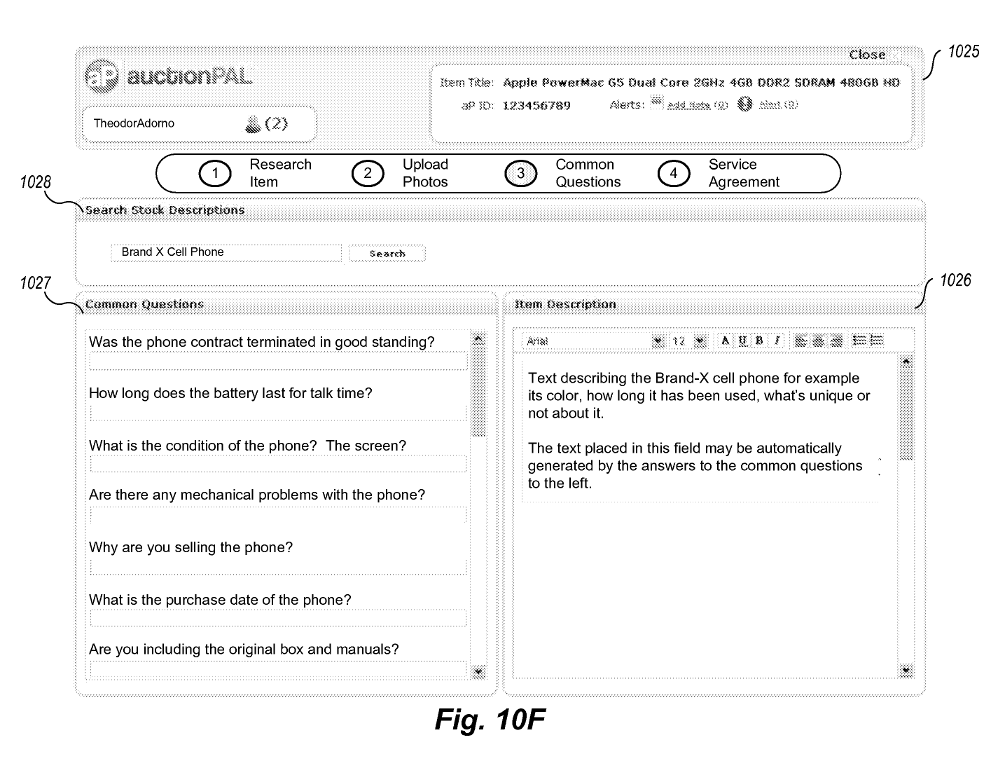

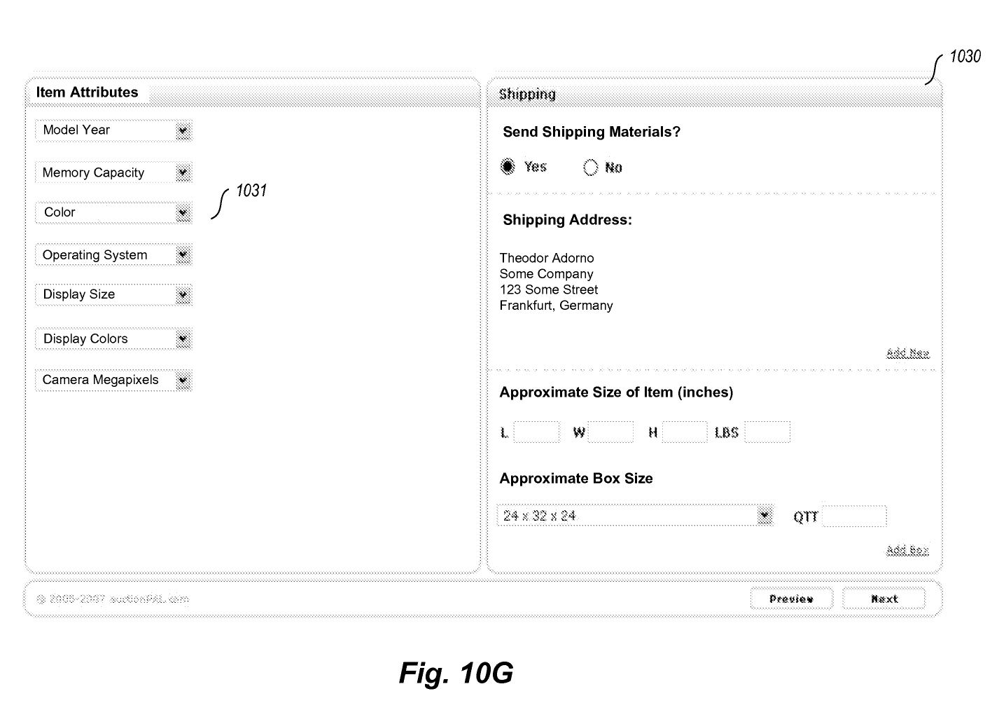

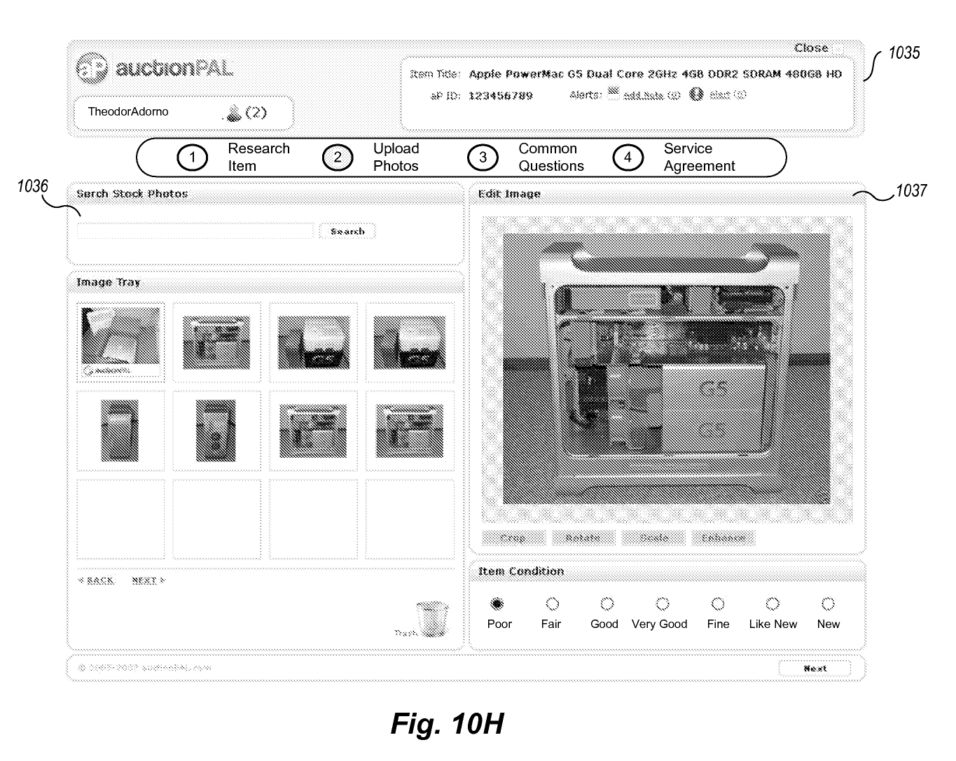

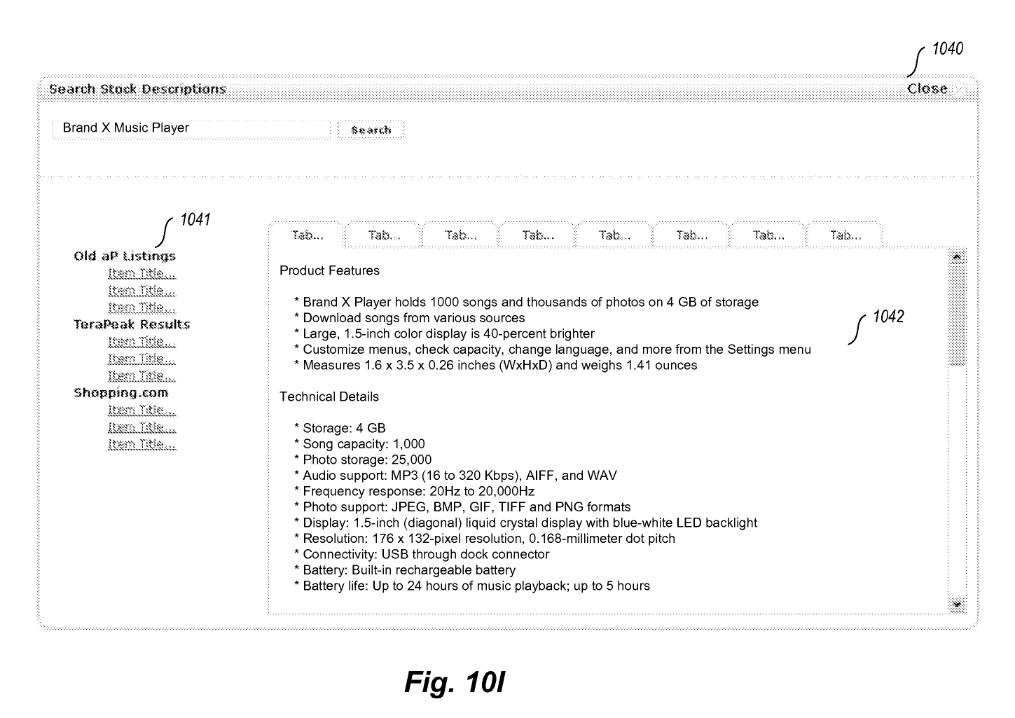

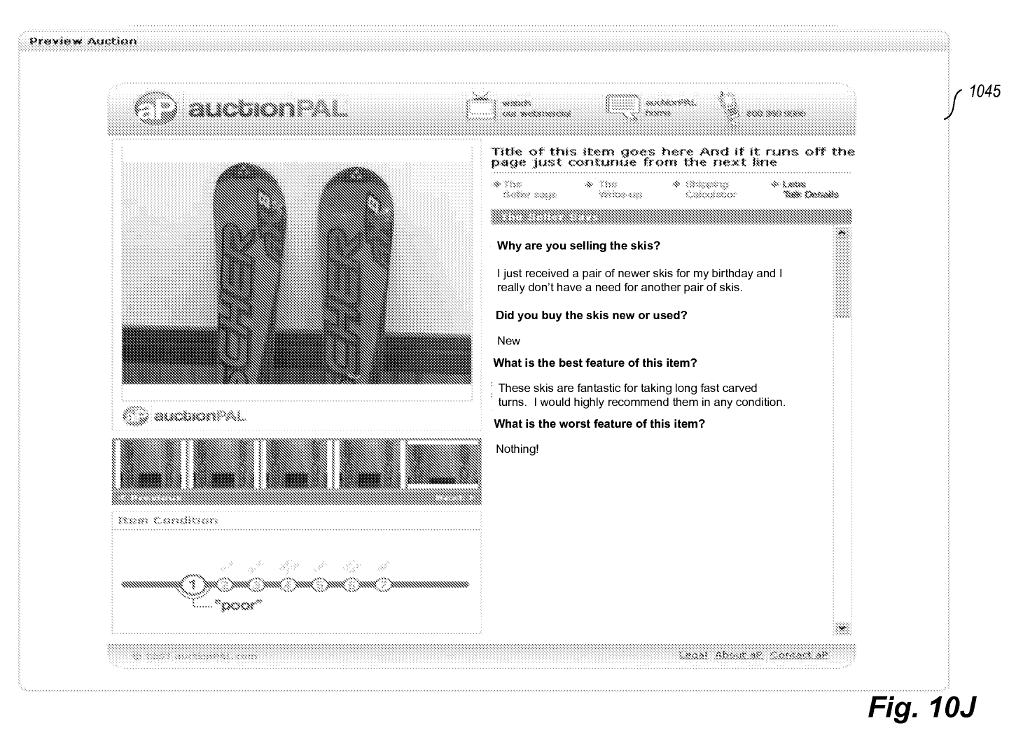

FIG. 10A-10J are example screen displays provided by a remote agent client application. The illustrated screens may be utilized by a remote agent to assist a seller who is, for example, engaging in the “remote agent assisted” sales model described with reference to FIG. 2, above. In particular, FIGS. 10A-10J illustrate screen displays provided by a remote agent client application (e.g., a Web browser) executing on, for example, remote agent client device 208 described with reference to FIG. 2. By utilizing functions provided by the illustrated screens, a remote agent may assist a seller in the listing of an item for sale via the EFS, approve a listing provided by a seller, and/or list an item via the EFS on behalf of a seller.

FIGS. 10A-10B depict screens that provide functionality for accessing and/or updating an account associated with a seller. In particular, FIG. 10A illustrates a customer lookup screen 1000 that may be used by a remote agent to look up a seller account. The customer lookup screen 1000 includes a search control 1001 that may be used by a remote agent to look up a customer by name and/or other criteria, a customer menu 1002 that may be used to browse for a customer, and a customer profile 1003 that may be used to display details about a customer. FIG. 10B illustrates a customer shipping details screen 1005 that may be used by a remote agent to specify a shipping address for a customer. A remote agent may utilize similar screens to provide other types of information about a customer (e.g., billing address, contact information, etc.).

FIGS. 10C-10E depict screens that provide functionality for researching and/or listing an item being offered for sale by a seller. In particular, FIG. 10C illustrates a research screen 1010 that includes a search control 1011, a search results area 1012, and an indication of suggested starting price 1013. The research screen 1010 may be used by a remote agent to obtain information about items (e.g., similar items, related items, items having common characteristics, etc.) being sold on various third-party item exchanges. Search results may be presented via the search results area 1012, which shows information about items sold on third-party item exchanges. In particular, the search results area 1012 may provide information such as the number of items listed, the average selling price of the items, and the percentage of items that eventually sold. The indication of suggested starting price 1013 may be automatically determined based on various factors, such as prices of similar items sold on third-party item exchanges and/or selected listed criteria, such as are described with reference to FIG. 10D, below.

FIG. 10D illustrates a research details screen 1015 that may be used to select or research the impact of various listing criteria. The research details screen 1015 provides listing criteria selection controls 1016a-1016d, including a promotion selection control 1016a, a duration selection control 1016b, an ending day selection control 1016c, and a timing selection control 1016d. The screen 1015 also includes listing criteria research data areas 1017a-1017d, including a promotion research data area 1017a, a duration research data area 1017b, an ending day research data area 1017c, and a timing research data area 1017d. For each of the listing criteria selection controls 1016a-1016d, research data that illustrates the impact of each listing criteria on sales outcomes (e.g., average sales price) are provided via corresponding listing criteria research data areas 1017a-1017d. For example, promotion research data area 1017a provides information regarding the impact of various promotions and/or features offered by one or more third-party item exchanges to enhance and/or encourage sales. Such promotions may include, for example, preferential item listing (e.g., at the top of a search results page as a “featured” listing), instant purchase options, emphasized listing styles (e.g., large headings or bold text to distinguish a particular listing). Furthermore, ending day research data area 1017c provides information regarding the impact of the ending day of a designated listing on the average sales price and other sales outcomes. Using such information a remote agent may make an informed selection of ending listing day via the ending day selection control 1016c. In some cases, the initial selections of the listing criteria selection controls 1016a-1016d may be automatically pre-populated or otherwise pre-selected based on optimal sales outcomes as determined by information obtained by the EFS, such as is displayed in the listing criteria research data areas 1017a-1017d. In other embodiments, a remote agent may completely bypass screens such as screen 1015 by requesting that the EFS automatically research and identify effective item listing criteria for a designated item.

FIG. 10E illustrates a calendar screen 1020 that provides information about the optimal time to list and/or sell items as well as scheduling functionality (e.g., scheduling an interview, a listing, and/or call-back with a seller, etc.). For example, based on research information such as that provided via screen 1015, above, a remote agent may determine that a seller would be better served delaying their offer to a later time, because the seller is likely to obtain a higher price at that time. For example, a seller who is attempting to sell skis in the summer may obtain a higher price if he delays the sale until the winter. In such cases, the remote agent may utilize the calendar screen 1020 to schedule a personal call back and/or automatic notification to be sent to the seller at the determined later time.

FIGS. 10F-10J depict screens that provide functionality for specifying information about an item being offered for sale by a seller. In particular, FIG. 10F illustrate an item description screen 1025 that provides an embedded editor 1026, a list of common questions 1027, and a stock description search control 1028. The editor 1026 may be utilized to draft an item description and/or modify an existing item description (e.g., one automatically provided by the EFS based on the type of item being sold and/or other information about the item). The list of common questions 1027 may be used by the remote agent as a an interview script, with which the remote agent may obtain detailed information about the item being offered for sale by the seller. In the illustrated example, the remote agent is in the process of listing a “Brand X” cellular telephone. Based the identity of the item being listed, the list of common questions 1027 has been automatically populated by the EFS with questions related to cellular telephones in general and/or the “Brand X” cellular telephone in particular. The stock description search control may be utilized to search for existing and/or pre-defined template descriptions, as described with reference to FIG. 10I, below.

FIG. 10G illustrates an item details screen 1030 that includes controls that may be used by a remote agent to specify detailed information about an item, such as dimensions and/or weight. In addition, screen 1030 includes controls 1031 that allow a remote agent to specify information and/or attributes specific to the item being listed. In some embodiments, such attributes may be specific to a particular third-party item exchange service. In particular, a third-party item exchange may provide listing criteria for various types of items (e.g., item category, item color, etc.) that may be obtained and utilized by the EFS to automatically generate listings that are targeted to that item exchange.

FIG. 10H illustrates a photo upload screen 1035 that may be used by a remote agent to provide images of an item being offered for sale. Such photos may be obtained from various sources, such as the EFS (e.g., which maintains a data store of stock photos), third-party item exchanges, and/or the seller. The photo upload screen 1035 includes a photo search control 1036 that may be utilized to search for stock photos of an item and an image editing control 1037 that may be utilized to manipulate (e.g., crop, scale, rotate) existing photos. In some embodiments, the EFS may additionally manage a collection of photo templates that have placeholders for specific types of images (e.g., front, back, top, bottom, etc.) that should be submitted. The photo templates may vary based on the type of item (e.g., a photo template for a car may include a greater number of photo placeholders than a template for a cellular telephone).

FIG. 10I illustrates a template description search screen 1040 that may be used by an agent to obtain a stock, pre-existing, and/or partially defined item description by searching and/or reviewing item descriptions associated with listings on third-party item exchanges and/or descriptions cached or otherwise stored by the EFS. In the illustrated example, the agent has searched for template descriptions for a “Brand X” music player, and as a result, has been presented with controls 1041 for selecting from various sources (e.g., the EFS, an item catalog, a third-party item exchange, etc.) template descriptions for related items (e.g., identical items, similar items, items having shared characteristics), as well as an example template description 1042.

FIG. 10J illustrates a listing preview screen 1045 that may be utilized to provide the agent and/or seller with a preview of an item listing created by use of the screens described with respect to FIGS. 10A-10I, above, and/or other functionality provided by the EFS.

FIG. 11 is an example block diagram of a computing system for practicing embodiments of an example Exchange Facilitator System. Note that a general purpose or a special purpose computing system may be used to implement an EFS. FIG. 11 illustrates a computer system 1100 that may comprise one or more server and/or client computing systems and may span distributed locations. In addition, each block shown may represent one or more such blocks as appropriate to a specific embodiment or may be combined with other blocks. Moreover, the various blocks of the illustrated system may physically reside on one or more machines, which use standard (e.g., TCP/IP) or proprietary interprocess communication mechanisms to communicate with each other.

In the embodiment shown, computer system 1100 comprises a computer memory (“memory”) 1101, a display 1102, a Central Processing Unit (“CPU”) 1103, Input/Output devices 1104 (e.g., keyboard, mouse, CRT or LCD display, etc.), and network connections 1105. An Exchange Facilitator System (“EFS”) 1110 is shown residing in memory 1101. The modules of the EFS 1110 preferably execute on CPU 1103 and cooperate to facilitate the sale of items by sellers via third-party item exchange systems. Other programs 1130 and potentially other data repositories, such as data repository 1120, also reside in the memory 1110, and preferably execute on one or more CPUs 1103. In a typical embodiment, the EFS 1110 includes an item listing criteria optimization module 1111, a user/account management module 1112, an item listing management module 1113, an EFS application program interface (“API”) 1114, and an EFS data repository 1115. The EFS 1110 may interact with EFS client devices 1155, third-party item exchange systems 1165, and other client devices 1160 via a network 1150, as described below.

In the illustrated embodiment, the EFS 1110 facilitates the sale of items by sellers and/or agents. The EFS 1110 obtains information about items being offered for sale via the EFS client devices 1155, such as the seller client device, local agent client device, and remote agent client device, as described with reference to FIG. 2. The EFS 1110 also obtains information about third party item exchange systems 1165 and items being sold on those systems. Using the obtained information, the EFS 1110 determines listing criteria and/or generates item listings that are electronically provided to one or more of the third-party item exchange systems 1165. In addition, the EFS 1110 manages the listing and sale of items by tracking the progress of items being sold on behalf of sellers on the third-party item exchange systems 1165. Additional details regarding the function, configuration, and/or operation of the EFS are generally provided with respect to FIGS. 1-3. Further details regarding the operation of the item listing criteria optimization module 1111, the user/account management module 1112, the item listing management module 1113, and the EFS data repository 1115 are provided with respect to the item listing criteria optimization engine 202, user/account management engine 204, the item listing management engine 203, and the EFS data repository 205, respectively, described with reference to FIG. 2, above.

The EFS API 1114 provides programmatic access to various features and/or functions of the EFS 1110. For example, the EFS API 1114 may provide a programmatic interface by which remote computing systems may programmatically interact with the EFS 1110, such as by providing information about items to sell, obtaining generated item listings and/or effective item listing criteria, etc. In addition, the API 1114 may also provide programmatic interface to a client application utilized by a user to interact with the EFS 1110 in various ways. For example, the functionality exposed via the API 1114 may support the development of custom applications operating on portable client devices (e.g., smart phones, PDAs, pagers, etc.), custom hardware (e.g., kiosk-based systems), etc.

In some embodiments, the EFS 1110 may include additional modules, such as a communications facilitator module that is configured to handle, process, and/or route communications between sellers, agents, and/or the EFS 1110. For example, the communications facilitator module may provide telephony functions, such as a private branch exchange (“PBX”) or other call routing capability for routing telephone calls between agents and sellers. In addition, various types of messaging functionality may be provided, such as receiving, forwarding, and/or sending various types of electronic messages (e.g., emails, text messages, video streams, audio messages, voice messages, multimedia messages, etc.).

In an example embodiment, modules of the EFS 1110 are implemented using standard programming techniques. However, a range of programming languages known in the art may be employed for implementing such example embodiments, including representative implementations of various programming language paradigms, including but not limited to, object-oriented (e.g., Java, C++, C#, Smalltalk), functional (e.g., ML, Lisp, Scheme, etc.), procedural (e.g., C, Pascal, Ada, Modula), scripting (e.g., Perl, Ruby, Python, etc.), etc.

One skilled in the art will recognize that the implementation described above uses well-known or proprietary synchronous and/or asynchronous client-server computing techniques. However, any of the EFS modules 1111-1115 may be implemented using more monolithic programming techniques as well. In addition, programming interfaces to the data stored (e.g., in the EFS data repository 1115) as part of the EFS 1110 can be available through standard programming techniques such as through C, C++, C#, and Java and through scripting languages such as XML, or through Web servers supporting such. The EFS data repository 1115 may be implemented for scalability reasons as a database system rather than as one or more text files, however any method for storing such information may be used. In addition, many of the modules may be implemented as stored procedures operating in the context of a data repository (e.g., a database management system), or methods attached to item exchange facilitation “objects,” although other techniques are equally effective.

The EFS 1110 may be implemented in a distributed environment comprising multiple, even heterogeneous, computer systems and networks. For example, in one embodiment, item listing criteria optimization module 1111, the user/account manager module 1112, the item listing management module 1113, and the EFS API 1114 are all located in physically different computer systems. In another embodiment, various modules of the EFS 1110 are hosted each on a separate server machine and may be remotely located from the tables which are stored in the data repository 1115. Different configurations and locations of programs and data are contemplated for use with techniques described herein. A variety of distributed computing techniques are appropriate for implementing the components of the illustrated embodiments in a distributed manner including but not limited to TCP/IP sockets, RPC (“Remote Procedure Call”), RMI (“Remote Method Invocation”), HTTP, Web Services (XML-RPC, JAX-RPC, SOAP, etc.). Also, other functionality could be provided by each module, or existing functionality could be distributed amongst modules in different ways, yet still achieve the functions of the EFS 1110.

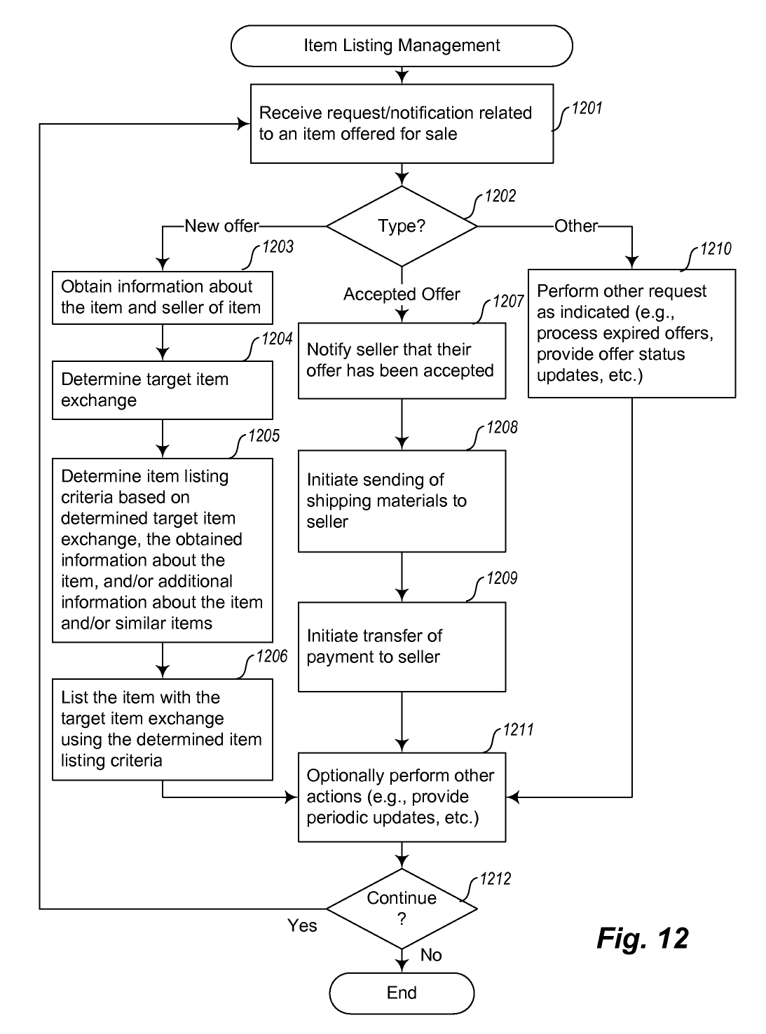

FIG. 12 is an example flow diagram of an example item listing management routine provided by an example embodiment of an Exchange Facilitator System. The illustrated routine may be provided by, for example, execution of the item listing management module 1113 of the EFS 1110, described with reference to FIG. 11. The illustrated routine manages the listing and sale of an item via one or more third-party item exchanges by performing intake of new items (e.g., obtaining information about items being offered for sale by sellers), generating listings for items, monitoring the progress of previously listed items, and finalizing purchase and delivery of items.

In step 1201, the routine receives a request or notification related to an item offered for sale. In step 1202, the routine determines the type of request or notification received. If the received request or notification is related to a new offer of an item for sale, the routine continues with step 1203. Such a request may be received from various sources, such as an seller operating a seller client device, a local or remote agent operating an agent client device, or some computing system/module configured to automatically provide information about items for sale to this routine. If the received request or notification is instead related to an accepted offer for sale, the routine continues with step 1207. Such a notification may be received from various sources, such as directly from a third-party item exchange, or from another computing system or module configured to monitor listings on a third-party item exchange and notify this routine of any changes to such listings (e.g., accepted offers, increased bids, closed sales, etc.). If the received request or notification is instead of some other type, the routine continues with step 1210.

In step 1203, the routine obtains initial information about the item and the seller of the item. Such information may be provided as part of the received request and may include an indication of the seller (e.g., a telephone number, an email address, a username, etc.) as well as an indication of the item (e.g., a textual description, a product number, a photograph, a universal product code number, etc.). In some embodiments, the routine may at this time obtain additional information about the item, such as by responding with a request for additional information based on the initial information (e.g., by presenting to the seller and/or agent one or more common questions, forms, dialog boxes, etc.).

In step 1204, the routine determines a target third-party item exchange. In some embodiments, determining a target item exchange may be performed automatically, based on information obtained in step 1205. For example, the routine may search and/or compare various third-party item exchanges, to determine which item exchange is most likely to result in a high sales price or other beneficial sales outcome for the seller. In some cases, the routine may instead search previously obtained information about third-party item exchanges, such as may be obtained by the item listing criteria optimization module 1111 and stored in the EFS data repository 1115, as described with reference to FIG. 11. In other embodiments, the determination of the target third-party item exchange may be based on user input, such as may be provided by an agent and/or seller (e.g., who specifies a preferred item exchange).

In step 1205, the routine determines item listing criteria based on the determined target item exchange, the obtained information about the item, and/or additional information about the item and/or related items. In the illustrated embodiment, the routine queries the EFS data repository 1115 to obtain a set of item listing criteria customized based on the item identity, the type and/or category of the item, the sales objectives of the seller and/or the EFS, the determined target item exchange, etc. The determined item listing criteria may include a recommended asking price, starting price, reserve price, posting date, auction date and/or time interval (e.g., start and end dates), special listing promotions (e.g., an instant purchase promotion used on an auction site, a preferred listing promotion, etc.), images of the item, descriptions of the item, etc.

In step 1206, the routine lists the item with the target item exchange using the determined item listing criteria. Listing the item may include automatically generating a listing based on the determined item listing criteria, and posting the generated listing on the target item exchange. In some embodiments, a listing may first be passed along to a human reviewer (e.g., an agent) associated with the EFS who first approves or otherwise reviews the item listing prior to submitting it to the target item exchange. In some embodiments, steps 1202-1206 may be performed in response to a single request (e.g., the request received in step 1201) received from a seller, user, or other computing system, so as to automatically generate an item listing based on initial information provided by the user, and to automatically provide that listing to a selected third-party item exchange, without any additional input or interaction. In addition, the routine may record an indication of the listing in the EFS data repository 1115, such that the listing can be monitored, tracked, or mined (e.g., for images to utilize as stock photos) by this routine, or other modules of the EFS. After step 1206, the routine proceeds to step 1211.

In step 1207, the routine notifies the seller of the item that their offer has been accepted. Such a notification may be provided in various ways, such as via email, text message, voice message, initiating an agent assisted telephone call, etc.

In step 1208, the routine initiates sending of shipping materials to the seller by, for example, notifying a shipping center associated with the EFS that is configured to send appropriately sized (e.g., automatically determined based on the dimensions of the sold item) shipping materials to an address (e.g., home, work, etc.) associated with the seller. In some embodiments, shipping materials may be sent prior to a final acceptance of an offer for sale. For example, in an auction context, shipping materials may in some cases be sent once a specified reserve price (e.g., a minimum acceptable price specified by the seller) has been met, such that the seller can send the item as soon as the auction closes. In addition, for sellers listing multiple items for sale, shipping materials for the multiple items may in some cases be sent together (e.g., in a single package), so as to reduce the cost of transporting the shipping materials to the seller.

In step 1209, the routine initiates transfer of payment to the seller. In the illustrated embodiment, the seller is paid when this routine receives a notification that the item has been sold. In other embodiments, the routine may instead hold payment in escrow (e.g., to prevent or inhibit fraud) until certain conditions have been met. For example, the routine may wait until the item has been received by the buyer, a predetermined amount of time has passed (e.g., 48 hours) and no complaints regarding the item have been received from the buyer, the buyer has been contacted (e.g., by an agent) and has confirmed that the item has been received and matches the description of the item as purchased, etc. In some embodiments, different payment techniques may be employed based upon various factors, such as reputation of the seller (e.g., based on not having been a subject of buyer complaints and/or positive feedback from buyers), the type of item (e.g., based on particular types of items tending to be the subject of fraudulent transactions), etc. After step 1209, the routine proceeds to step 1211.

In step 1210, the routine performs or responds to the other request or notification. Various other types of requests and/or notifications may be handled by this step. For example, the routine may receive a request to process expired item offers (e.g., items that have been listed on an item exchange but have not sold after a particular time interval) and in response, notify the sellers of those items accordingly. In addition, the routine may receive a request to provide a status update for one or more items that have previously been listed on a third-party item exchange and in response, determine the status of those items and notify associated sellers, agents, or other parties accordingly. After step 1210, the routine proceeds to step 1211.

In step 1211, the routine optionally performs other actions as appropriate. In some embodiments, the routine may periodically (e.g., every day or other determined time interval) notify sellers associated with all active listings of the status (e.g., current bid price) of their items being offered for sale. In this step, the routine may also perform logging functions, so as to track usage of the routine for analytic and/or billing purposes. In step 1212, the routine determines whether to continue and if so, proceeds to step 1201 to continue processing requests or notifications, else ends. The routine may, for example, determine not to continue if it receives a shutdown request.

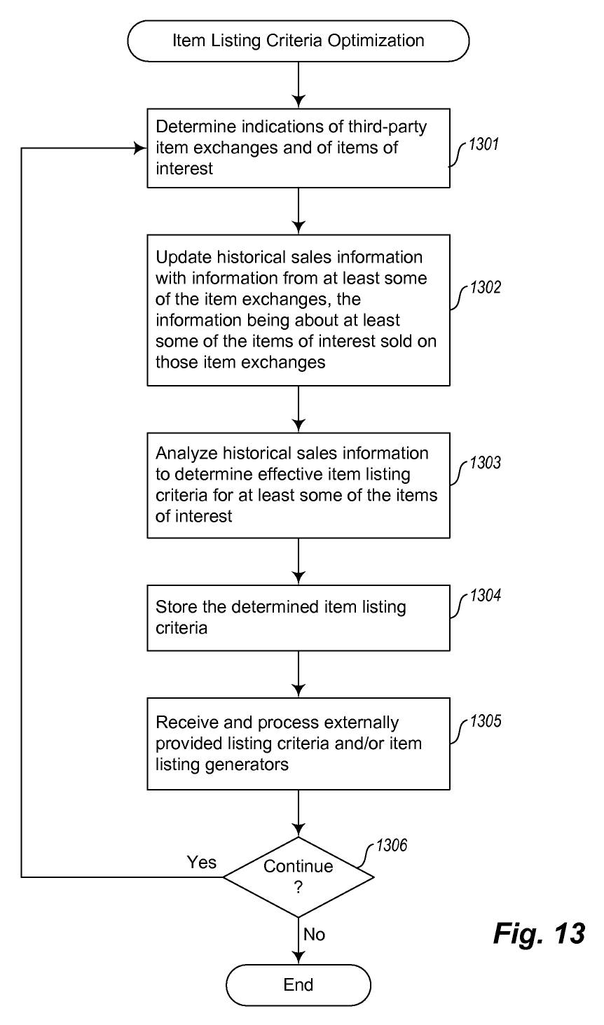

FIG. 13 is an example flow diagram of an example item listing criteria optimization routine provided by an example embodiment of an Exchange Facilitator System. The illustrated routine may be provided by, for example, execution of the item listing criteria optimization module 1111 of the EFS 1110, described with reference to FIG. 11. The illustrated routine obtains information about third-party item exchanges, analyzes the obtained information to determine effective item listing criteria, and stores the determined item listing criteria for use by other system modules, such as the item listing management module 1113, described with reference to FIG. 11.

In step 1301, the routine determines indications of third-party item exchanges and of items of interest. In the illustrated embodiment, the EFS tracks information about multiple third-party item exchanges and multiple items. In this step, the routine selects some subset of the multiple third-party item exchanges and some subset of the multiple items. Selecting these subsets may be based on various factors, such as average item sales price, historical item sales variability, item sales volume associated with a third-party exchange, and other characteristics that may be derived manually, heuristically, or algorithmically depending on the degree of “intelligence” programmed into the EFS. As such, the routine may preferentially obtain, update, and/or process information about items and/or third-party exchanges that have particularly dynamic sales characteristics, so as to focus its effort on obtaining and/or providing up-to-date information about high-demand (or other classes of) items. Other selection schemes may of course also be used, such as a round-robin scheme that updates information about items and/or item exchanges on a regularized and/or scheduled basis (e.g., information about items is updated in alphabetical order by the name of the item).

In step 1302, the routine updates historical sales information with information from at least some of the determined item exchanges, the information being about at least some of the items of interest sold on those item exchanges. In this step, the routine obtains information about the items of interest from at least some of the determined item exchanges. This may include obtaining information about sales transactions (e.g., new listings, existing listings, closed listings, etc.) occurring on each of the item exchanges. In some cases, the item exchanges may provide an API or data feed that provides such information in a formalized, machine-readable manner. In other cases, the routine may invoke a harvester, scraper, or robot to access a Web site or other information resource provided by an item exchange, and parse or otherwise process the accessed Web site in order to obtain information about items of interest. Once the routine has obtained information about the items of interest, the routine updates historical sales information for those items of interest that is recorded in, for example, EFS data repository 1115. This historical information may then be utilized by other modules and/or humans (e.g., an agent or a seller), or by other steps of this routine.

In step 1303, the routine analyzes the historical sales information to determine effective item listing criteria for at least some of the items of interest. In this step, the routine may apply various techniques to determine effective item listing criteria for the items of interest. For example, the routine may identify or discover characteristics and/or features associated with item sales that are correlated with various sales objectives and/or outcomes, such as item price, sale time, etc. Such characteristics may be automatically discovered by the EFS in various ways, such as by statistical analysis, machine learning, Bayesian networks, artificial intelligence, decision trees, etc. In some embodiments, the analysis may include at least some human input, such as by human analysts employed by the EFS to identify effective item listing criteria based on historical item sales.

In step 1304, the routine stores the determined item listing criteria. The routine may store the determined item listing criteria in the EFS data repository 1115, such that they may be utilized by other modules (e.g., the item listing management module 1113), humans, and/or other steps of this routine. The determined item listing criteria may be associated with particular types and/or classes of items, as well as with the specific items of interest processed by this routine.

In step 1305, the routine receives and processes (e.g., stores) externally provided item listing criteria and/or item listing generators. In the illustrated embodiment, the routine also manages the acquisition of effective item listing criteria specified by humans, based on research and analysis undertaken by those humans. In addition, the routine also manages the acquisition of item listing generators, which may include sets or groups of common questions that may be utilized to prompt a seller and/or agent to provide specific information about particular types of items. Item listing generators may also include computer programs (e.g., code modules, scripts, etc.) that may be executed to automatically process information about items being offered for sale in order to generate an item listing (or information to be used for an item listing), possibly based on the various criteria determined by this routine. Item listing generators also may be associated with, and specialized for, particular types of items.

In step 1306, the routine determines whether to continue and if so, proceeds to step 1301 to continue processing, else ends. The routine may, for example, determine not to continue if it receives a shutdown request.

As noted with reference to FIG. 11, above, some embodiments provide and/or implement an Application Program Interface (“API”) that provides access to at least some of the functionality and/or services of the EFS. Table 1 describes an example API that may be used by, for example, a local agent client device to interact with the EFS.

TABLE 1

| | Operation | |
|---|---|---|
| Operation Name | Arguments | Operation Semantics |
| GetCategories | | Provide a list of all item |
| | | categories. |
| GetQuestions | | Provide a list of all common |
| | | questions. |
| GetQuestionCategories | | Provide a list of associations |
| | | between item categories and |
| | | common questions. |
| GetBoxSizes | | Provide a list of associations |
| | | between item categories and |
| | | box sizes. |
| GetCustomers | agentID | Provide list of all customers |
| | | associated with the agent |
| | | identified by agentID. |
| Research | keywords | Provide search results based |
| | category | on the provided keywords, |
| | timeInterval | category, and/or time interval. |
| PostItem | customerID | List a new item associated |
| | title | with the identified customer. |
| | quantity | The listing is based on the |
| | condition | provided title, quantity, |
| | categoryID | condition, category, and |
| | description | description. Description may |
| | | include text and/or binary |
| | | data (e.g., photo, audio |
| | | recording, etc.) |
| RegisterClient | name | Create a new account based |
| | phoneNumber | on the provided name, phone |
| | address | number, address, and customer |
| | signature | signature. |

The API illustrated in Table 1 may be implemented in various ways, such as via an XML-based protocol (e.g., SOAP, XML-RPC) over HTTP. Other embodiments may utilize other implementation techniques, such as Remote Procedure Call, Remote Method Invocation, and/or proprietary techniques.

All of the above U.S. patents, U.S. patent application publications, U.S. patent applications, foreign patents, foreign patent applications and non-patent publications referred to in this specification and/or listed in the Application Data Sheet, including but not limited to U.S. Provisional Patent Application No. 60/865,814, entitled “METHOD AND SYSTEM FOR FACILITATING EXCHANGE OF GOODS,” filed Nov. 14, 2006, is incorporated herein by reference, in its entirety.

From the foregoing it will be appreciated that, although specific embodiments of the invention have been described herein for purposes of illustration, various modifications may be made without deviating from the spirit and scope of the invention. For example, one skilled in the art will recognize that the methods and systems for facilitating item exchange discussed herein are applicable to other architectures and topologies other than the Internet and Web browsers. One skilled in the art will also recognize that the methods and systems discussed herein are applicable to differing protocols, communication media (optical, wireless, cable, etc.) and devices (such as wireless handsets, electronic organizers, personal digital assistants, portable email machines, game machines, pagers, navigation devices such as GPS receivers, etc.).

1. A computer-implemented method for facilitating an exchange of items, comprising:
receiving from a remote computing system information about an item offered for sale by a seller, the received information including an indication of the item and an indication of the seller;
determining item listing criteria for the item by analyzing transactions associated with the third-party item exchange, the transactions including sales of other items that relate to the item offered for sale by the seller; and
facilitating sale of the item in the third-party item exchange by electronically providing an item listing to the third-party item exchange, the item listing based on at least the received information and determined item listing criteria.

2. The method of claim 1 wherein the received information includes at least one of an address associated with the seller, a customer identifier associated with the seller, or payment information associated with the seller.

3. The method of claim 1 wherein the received information includes at least one of a textual description of the item, an image of the item, an indication of a category that includes the item, or a product identifier associated with the item.

4. The method of claim 1 wherein the determined item listing criteria include factors associated with high sales prices of items on the third-party exchange.

5. The method of claim 1 wherein the determined item listing criteria include at least one of a reserve price to be associated with the item, an asking price to be associated with the item, a day of week to begin and/or end listing of the item, a time of day to begin and/or end listing of the item, a description of the item, an image of the item, or a promotion offered by the third-party exchange.

6. The method of claim 1 wherein the analyzing of the transactions associated with the third-party item exchange includes identifying aspects of item listings associated with the sales of the other items, the aspects correlated with specified sales outcomes.

7. The method of claim 1 wherein at least some of the sales of the other items are of items that are in a category that includes the item offered for sale and are for items that are not identical to the item offered for sale.

8. The method of claim 1, further comprising:
determining one or more questions, based at least in part on the received information about the item offered for sale; and
obtaining additional information about the item offered for sale by providing the determined questions to the remote computing system.

9. The method of claim 8 wherein the item listing is based at least in part on the obtained additional information.

10. The method of claim 8 wherein the determining of the one or more questions includes selecting the one or more questions based on a category associated with the item offered for sale.

11. The method of claim 8 wherein the one or more questions are directed to at least one of age of the item offered for sale, condition of the item offered for sale, a warranty associated with the item offered for sale, or a reason for offering for sale the item offered for sale.

12. The method of claim 1, further comprising selecting the third-party item exchange, based on a comparison of multiple third-party item exchanges to determine which of the multiple third-party item exchanges is likely to result in the highest selling price for the item offered for sale.

13. The method of claim 1 wherein the third-party item exchange is at least one of an online auction site, an electronic storefront, or an electronic marketplace.

14. The method of claim 1 wherein the method is performed by an exchange facilitator system, and wherein the remote computing system is a mobile computing device operated by an agent who obtains at least some of the received information from the seller.

15. The method of claim 1 wherein the item listing is automatically generated based on the received information and the determined item listing criteria.

16. The method of claim 1 wherein the determining item listing criteria for the item by analyzing transactions associated with the third-party item exchange comprises:
automatically determining item listing criteria for the item by electronically analyzing transactions associated with the third-party item exchange.

17. The method of claim 1 wherein the facilitating the sale of the item includes at least one of notifying the seller that the item has been sold, providing shipping materials for the item to the seller, or providing payment to the seller.

18. A computing system configured to facilitate an exchange of items, comprising:
a memory;
a module stored on the memory that is configured, when executed, to:
receive from a remote computing device information about an item offered for sale by a seller, the information including an indication of the item;
determine item listing criteria for the item by analyzing transactions associated with the third-party item exchange;
automatically generate an item listing based on the received information and the determined item listing criteria; and
facilitate sale of the item via the third-party item exchange by electronically providing the generated item listing to the third-party item exchange.

19. The computing system of claim 18 wherein the module is further configured, when executed, to automatically determine the item listing criteria for the item by electronically analyzing transactions associated with the third-party item exchange.

20. The computing system of claim 18 wherein the module includes software instructions for execution in the memory of the computing system.

21. The computing system of claim 18 wherein the module is an exchange facilitator system.

22. The computing system of claim 18 wherein the remote computing device is at least one of a desktop computer, a laptop computer, a smart phone, a personal digital assistant, or a cell phone.

23. The computing system of claim 18 wherein the computing system is operated by an entity distinct from an entity that operates the third-party item exchange.

24. A computer-readable medium whose contents enable a computing device to facilitate an exchange of items, by performing a method comprising:
obtaining information about an item offered for sale by a seller, the information including an indication of the item and an indication of the seller; and
electronically transmitting the obtained information to a remote computing system configured to facilitate sale of the item using a third-party item exchange, the remote computing system configured to facilitate the sale of the item by:
determining item listing criteria for the item by analyzing transactions associated with the third-party item exchange, the transactions including sales of other items that are similar to the item offered for sale by the seller; and
forwarding an item listing based on the obtained information and the determined item listing criteria to the third-party item exchange.

25. The computer-readable medium of claim 24 wherein the computer-readable medium is at least one of a memory in a computing device or a data transmission medium transmitting a generated signal containing the contents.

26. The computer-readable medium of claim 24 wherein the contents are instructions that when executed cause the computing system to perform the method.

27. The computer-readable medium of claim 24 wherein the computing device is at least one of a desktop computer, a laptop computer, a smart phone, a cell phone, or a personal digital assistant.

28. The computer-readable medium of claim 24 wherein the obtaining the information includes capturing an image of the item.

29. The computer-readable medium of claim 24 wherein the transmitting of the obtained information includes sending the information over a wireless network to the remote computing system.

30. A method for facilitating an exchange of items, comprising:
presenting a user interface on a computing device for facilitating the exchange of items;
obtaining from the presented interface information about an item offered for sale by a seller, the information including an indication of the item and an indication of the seller; and
transmitting the obtained information about the item to a remote computing system configured to facilitate sale of the item using a third-party exchange, the remote computing system configured to facilitate the sale of the item by providing to the third-party exchange a listing for the item, the listing based on the obtained information; and
initiating transport of shipping materials to the seller based upon the obtained information, such that when the item is sold to a buyer, the seller can use the shipping materials to send the item to the buyer.

31. The method of claim 30 wherein the computing device is a mobile computing device operated by a human agent who receives at least some of the obtained information from the seller.

32. The method of claim 30 further comprising, presenting one or more questions on the presented interface, each question requesting additional information about the item offered for sale.

33. The method of claim 30 further comprising, initiating a conference with a remote agent who obtains additional information from the seller and who generates the listing for the item based at least in part on the obtained additional information.

34. The method of claim 30 wherein the remote computing system is further configured to automatically generate the listing for the item, the generated listing based at least in part on item listing criteria determined by the remote computing system.

35. The method of claim 34 wherein the remote computing system is further configured to automatically generate the item listing criteria.

36. The method of claim 34 wherein the item listing criteria are based at least in part on information about transactions for other items that are similar to the item offered for sale, the transactions occurring on one or more third-party item exchanges.

37. The method of claim 30 wherein the shipping materials include at least one of a mailer, a box, a carton, packing tape, cushioning materials, or shipping instructions.

38. The method of claim 30 wherein the shipping materials are automatically selected based on the obtained information.

39. The method of claim 30 wherein the shipping materials are pre-addressed with a destination address associated with the buyer.

40. The method of claim 30 further comprising, initiating a payment to the seller based on a price paid by the buyer and a commission.
